(19) United States
(12) Patent Application Publication
(10) Pub. No.: US 2023/0340164 A1
(43) Pub. Date: Oct. 26, 2023

(54) USE OF AN ACTIVATABLE, DE-ESTERIFIED, PECTIN-CONVERTED FRUIT FIBER FOR THE MANUFACTURING OF PRODUCTS

(71) Applicant: Herbstreith & Fox GmbH & Co. KG Pektin-Fabriken, Neuenbürg (DE)

(72) Inventor: Gerhard F. Fox, Neuenbürg (DE)

(21) Appl. No.: 18/040,429

(22) PCT Filed: Aug. 3, 2021
(86) PCT No.: PCT/EP2021/071685

§ 371 Date: Feb. 3, 2023

(30) Foreign Application Priority Data
Aug. 5, 2020 (DE) 10 2020 120 606.2
Oct. 2, 2020 (DE) 10 2020 125 841.0

(51) Int. Cl. C08B 37/00; A23L 33/24; A23L 29/231; A23L 29/262; A23K 10/37; A23K 20/163; C08L 5/06; D01C 1/00

(52) U.S. Cl. CPC C08B 37/0045; A23K 10/37; A23K 20/163; A23L 29/231; A23L 29/262; A23L 33/24; C08B 37/0048; C08L 5/06; D01C 1/00; C08L 2205/16

(57) ABSTRACT

The present invention relates to the use of an activatable, de-esterified, pectin-converted fruit fiber for preparing products in the food or non-food area. The invention also relates to products containing the activatable, de-esterified, pectin-converted fruit fiber.

The present invention relates to the use of an activatable, de-esterified, pectin-converted fruit fiber for the manufacturing of products in the food or non-food area. The invention also relates to products containing the activatable, de-esterified, pectin-converted fruit fiber.

### BACKGROUND OF THE INVENTION

Dietary fibers are largely non-digestible food components, mostly carbohydrates, which predominantly exist in plant-based foods. For purposes of simplicity, fibers are divided into water-soluble fibers, such as pectin, and water-insoluble fibers, such as e. g. cellulose. Dietary fibers are considered to be an important part of the human diet.

Thus, the consumption of dietary fibers is considered to promote health. The use of fruit fibers, such as sugar beet, apple or citrus fibers, as dietary fibers in the production of food is gaining increasing importance. One reason is that fruit fibers are mixtures of insoluble fibers such as cellulose and soluble fibers such as pectin, resulting in an ideal spectrum of health-promoting activity. The functional properties of food products may be modified by use of fruit fibers like citrus fibers or apple fibers. Nowadays, fruit fibers are also employed in non-food products.

Thus, U.S. 5,964,983 teaches the use of a microfibrillar cellulose produced from sugar beets as a thickener for colors or drilling fluids. The method disclosed in U.S. 5,964,983, however, requires great effort since it comprises an acid or alkaline extraction, followed by an aqueous washing step, pressure homogenization, an ethanolic washing step and drying. In addition, the fiber properties are shown to change substantially, depending on the production method, consequently determining usability for the optimization of food or non-food products.

Thus, there is a demand for improved pectin-containing fruit fibers and the new or improved possibilities of their usage resulting therefrom.

The objective of the present invention thus is to provide an improvement or an alternative to the prior art.

### SUMMARY OF THE INVENTION

In a first aspect of the present invention, the objective is achieved by use of an activatable, de-esterified, pectin-converted fruit fiber for manufacturing a product, selected from the group consisting of food products, feeding stuff, commodity goods, animal need, hygiene products, personal care products, cleaning agents, coating agents, care agents, explosives, lubricants, cooling agents, plastic products, fabrics, imitation leather, varnish, ink, paints, building materials, composite materials, paper, cardboard, adhesive, fertilizers, drugs, medical products, batteries, wherein the activatable, de-esterified, pectin-converted fruit fiber has a content of water-soluble pectin of between 5 to 35 wt%. Here, it is preferred that the activatable, de-esterified, pectin-converted fruit fiber is an activatable, de-esterified, pectin-converted citrus fiber or an activatable, de-esterified, pectin-converted apple fiber.

The activatable, de-esterified, pectin-converted fruit fiber advantageously has a content of water-soluble pectin of between 10 to 35 wt% and particularly preferably of between 15 to 30 wt%. The content of water-soluble pectin in the activatable, de-esterified, pectin-converted citrus fiber can be, for example, 11 wt%, 12 wt%, 13 wt%, 14 wt%, 15 wt%, 16 wt%, 17 wt%, 18 wt%, 19 wt%, 20 wt%, 21 wt%, 22 wt%, 23 wt%, 24 wt%, 25 wt%, 26 wt%, 27 wt%, 28 wt%, 29 wt%, 30 wt%, 31 wt%, 32 wt%, 33 wt% or 34 wt%.

The production method described in the following results in activatable, de-esterified, pectin-converted fruit fibers with a large internal surface, which also increases water-binding capacity and contributes to a good viscosity formation. Especially in calcium-containing applications a significant gelation can additionally be observed.

These fibers are activatable fibers that display satisfactory firmness due to the partial activation of the manufacturing process. However, to obtain optimal rheological properties like viscosity, gelation or texturing, additional shear forces are required in application for the user. These are thus partially activated fibers which can, however, be further activated. The term “partially activated fibers” is thus synonymous with the term “activatable fibers” in the context of the present application.

Additionally, the activatable, de-esterified, pectin-converted fruit fiber used according to the invention has a more potent effectiveness. Compared to modified starch, less than half the amount needs to be employed to produce a fat-containing cream with comparable baking stability.

The activatable de-esterified, pectin-converted fruit fiber (e.g. water-soluble pectin content approx. 35 wt% in the case of the citrus fiber and 22 wt% in the case of the apple fiber) and low-esterified fruit fiber obtained by the process described herein is in the context of the invention also referred to as “de-esterified fruit fiber” or, more specifically in individual cases, as “de-esterified apple fiber” or “de-esterified citrus fiber”.

The inventors have found the citrus fibers produced with the method described below to exhibit good rheological characteristics. The fibers used according to the invention can be easily rehydrated in calcium-free water, and the advantageous rheological properties remain even after rehydration.

The inventors have found the activatable, de-esterified, pectin-converted fruit fibers according to the invention to be to a high degree without taste and smell, which makes them advantageously usable for the application in the food industry. The inherent flavor of the other ingredients is not masked and can therefore develop optimally.

The activatable, de-esterified, pectin-converted fruit fibers are extracted from fruits and thus represent natural ingredients with known beneficial properties.

Vegetable processing residues such as apple pomace or citrus pomace can be used as raw material in the production process described below. These processing residues are inexpensive, are available in sufficient quantities and offer a sustainable and ecologically sensible source for the fruit fibers that can be used according to the invention.

Fruit fibers are well-established and accepted in the food industry so that respective compositions can be immediately used without lengthy admission procedures, even internationally.

### DETAILED DESCRIPTION OF THE INVENTION

In a second aspect, the invention relates to the use of an activatable, de-esterified, pectin-converted fruit fiber in the construction area, in extraction by drilling of boreholes and in the agricultural field, characterized in that the activatable, de-esterified, pectin-converted fruit fiber has a content of water-soluble pectin of between 5 to 35 wt%. Here, it is preferred that the activatable, de-esterified, pectin-converted fruit fiber is a de-esterified citrus fiber or a de-esterified apple fiber.

In the uses taught above, the activatable, de-esterified, pectin-converted fruit fiber used according to the invention can have one or more of the following functions: as a foaming agent, a whipping agent, a release agent, a free flow agent, a stabilizer, an emulsifier, a carrier, a filler, a texturing agent, a thickener, a gelling agent, a solidifying agent, a dietary fiber, a reinforcing agent, a humectant, a filter aid, an egg substitute, a glazing agent, an improving agent for freeze-thaw stability and an improving agent for baking stability.

The invention relates to the use of an activatable, de-esterified, pectin-converted fruit fiber. Such an activatable, de-esterified, pectin-converted fruit fiber can be obtained from pomace such as apple, or citrus pomace, which is digested by incubation of an aqueous suspension of citrus or apple pomace as starting material.

### The Activatable, De-Esterified, Pectin-Converted Fruit Fiber

The activatable, de-esterified, pectin-converted fruit fiber is preferably an activatable, de-esterified, pectin-converted citrus fiber or an activatable, de-esterified, pectin-converted apple fiber. In detail:

### The De-Esterified Citrus Fiber

The activatable, de-esterified, pectin-converted citrus fiber used according to the invention has a water-soluble pectin content of 10 to 35 wt%, the pectin having a degree of esterification of less than 50% and thus being a low methoxyl pectin. This activatable low methoxyl pectin-containing citrus fiber is also briefly referred to as “de-esterified citrus fiber” in the context of the invention. This de-esterified citrus fiber is preferably obtainable by, or obtained by, the process described herein.

The de-esterified citrus fiber used according to the invention advantageously has a water-soluble pectin content of between 10 wt% and 35 wt%, and particularly preferably between 15 and 30 wt%. The content of water-soluble pectin in the activatable, de-esterified, pectin-converted citrus fiber can be, for example, 10 wt%, 11 wt%, 12 wt%, 13 wt%, 14 wt%, 15 wt%, 16 wt%, 17 wt%, 18 wt%, 19 wt%, 20 wt%, 21 wt%, 22 wt%, 23 wt%, 24 wt%, 25 wt%, 26 wt%, 27 wt%, 28 wt%, 29 wt% or 30 wt%.

The de-esterified citrus fiber exhibits advantageous characteristics in terms of texturization and viscosification behavior, which can be read off from the yield point and dynamic Weissenberg number, respectively. Accordingly, the de-esterified citrus fiber may exhibit one or more of the following characteristics with respect to yield point and dynamic Weissenberg number, and advantageously may satisfy all of these characteristics.

In one embodiment, the de-esterified citrus fiber in a 2.5 wt% aqueous suspension has a yield point II (rotation) of greater than 0.1 Pa, advantageously greater than 0.6 Pa, and particularly advantageously 1.0 Pa.

In one embodiment, the de-esterified citrus fiber in a 2.5 wt% aqueous suspension has a yield point II (cross over) of greater than 0.1 Pa, advantageously of greater than 0.4 Pa, and particularly advantageously of greater than 0.6 Pa.

In one embodiment, the de-esterified citrus fiber in a 2.5 wt% aqueous dispersion has a yield point I (rotation) of greater than 1.0 Pa, advantageously of greater than 3.5 Pa, and particularly advantageously of greater than 5.5 Pa.

In one embodiment, the de-esterified citrus fiber in a 2.5 wt% aqueous dispersion has a yield point I (cross over) of greater than 1.0 Pa, advantageously of greater than 4.0 Pa, and particularly advantageously of greater than 6.0 Pa.

Advantageously, the de-esterified citrus fiber in a 2.5 wt% aqueous suspension has a dynamic Weissenberg number greater than 5.5, advantageously greater than 6.5, and particularly advantageously greater than 8.0.

Advantageously, the de-esterified citrus fiber in a 2.5 wt% aqueous dispersion has a dynamic Weissenberg number greater than 6.0, advantageously greater than 7.0, and particularly advantageously greater than 8.5.

For the de-esterified citrus fiber, the features of the above-described characteristics with respect to yield point and dynamic Weissenberg number may also be combined in any permutation, if desired. Thus, in a particular embodiment, the de-esterified citrus fiber used according to the invention may have all the characteristics with respect to yield point and dynamic Weissenberg number, wherein said de-esterified citrus fiber preferably is obtainable by the present process or obtained thereby.

To determine yield point I (rotation), yield point I (cross over), and dynamic Weissenberg number in a 2.5 wt% aqueous dispersion, the de-esterified citrus fiber is dispersed as a 2.5 wt% aqueous solution according to the method disclosed in the examples, and the measurement is made after 1 h at 20° C.

To determine yield point II (rotation), yield point II (cross over) and dynamic Weissenberg number in a 2.5 wt% aqueous suspension, the de-esterified citrus fiber is suspended as a 2.5 wt% aqueous solution according to the method disclosed in the examples, measurement is carried out after 1 h at 20° C.

In an advantageous embodiment, the de-esterified citrus fiber has, in a 4 wt% aqueous suspension, a firmness of greater than 100 g, preferably of greater than 125 g, and particularly preferably of greater than 150 g.

According to a particular embodiment, the de-esterified citrus fiber in a composition with 22°Brix and 2.5 wt% fiber concentration has a breaking strength of 50 HPE or greater, advantageously of greater than 150 HPE and even more advantageously of greater than 250 HPE. The comparatively high breaking strength is due to the low methoxyl pectin. For example, the breaking strength may be 50, 60, 70, 80, 90, 100, 110, 120, 130, 140, 150, 160, 170, 180, 190, 200, 210, 220, 230, 240, 250, 270, 300 or 400 HPE for 2.5 wt% fiber concentration at 22°Brix.

According to a particular embodiment, the de-esterified citrus fiber in a composition with 40°Brix and 2.5 wt% fiber concentration has a breaking strength of 250 HPE or greater, advantageously of greater than 500 HPE and even more advantageously of greater than 700 HPE. The comparatively high breaking strength is due to the low methoxyl pectin. For example, the breaking strength may be 250, 300, 350 400, 450, 500, 550, 600, 650, 700, 800, 900 or 1000 HPE for 2.5 wt% fiber concentration at 40°Brix.

According to the present invention, the term “breaking strength” is a measure of the strength of a gel prepared with sucrose in a buffer solution at pH about 3.0 and formed at 22°Brix or 40°Brix. The breaking strength is determined after cooling in a water bath at 20° C. for two hours. The breaking strength is determined using the Herbstreith Pektinometer Mark IV or an equivalent precursor model. The method used is hereinafter referred to as the breaking strength test, the measured value as the breaking strength, and the unit of measurement is Herbstreith Pektinometer Units (HPE).

Preferably, the de-esterified citrus fiber has a viscosity of greater than 300 mPas, preferably of greater than 400 mPas, and particularly preferably of greater than 500 mPas, wherein the de-esterified citrus fiber is dispersed in water as a 2.5 wt% solution and the viscosity is measured with a shear rate of 50 s⁻¹ at 20° C. For example, the de-esterified citrus fiber may have a viscosity of 325, 350, 375, 400, 425, 450, 475, 500, 525, 550, 575, 600, 625, 650, 675, 700, 725, 750, 775, 800, 825, 850, 875, 900, 925, 950, 975 or 1000 mPas.

For determining viscosity, the citrus fiber is dispersed in demineralized water with the method disclosed in the examples as a 2.5 wt% solution, and viscosity is determined at 20° C. and four shearing sections (first and third section = constant profile; second and fourth section = linear ramp; each measurement at a shearing speed of 50 s⁻¹) (rheometer; Physica MCR series, measuring bob CC25 [corresponding to Z3 DIN], Anton Paar company, Graz, Austria). The advantage of a de-esterified citrus fiber with such a high viscosity is that a lower amount of fiber is necessary for thickening the final product. In addition, the fiber thus creates a creamy texture.

The de-esterified citrus fiber advantageously has a water binding capacity of more than 22 g/g, preferably of more than 24 g/g, and particularly preferably of more than 26 g/g. Such an advantageously high-water binding capacity leads to a high viscosity and consequently also to a lower fiber consumption with a creamy texture.

According to one embodiment, the de-esterified citrus fiber has a moisture of less than 15%, preferably less than 10% and particularly preferably less than 8%.

It is also preferable for the de-esterified citrus fiber to have, in a 1.0% aqueous solution, a pH value of 3.0 to 7.0 and preferably of 4.0 to 6.0.

The de-esterified citrus fiber advantageously has a particle size in which at least 90% of the particles are smaller than 450 µm, preferably smaller than 350 µm and particularly preferably smaller than 250 µm.

In one advantageous embodiment, the de-esterified citrus fiber has a lightness value of L* > 84, preferably L* > 86 and particularly preferably L* > 88. This means that the citrus fibers are virtually colorless and do not cause any significant discoloration of the products when used in food products.

Advantageously, the de-esterified citrus fiber has a dietary fiber content of 80 to 95%.

Due to the acid disintegration, the pectin of the citrus fiber has been altered in such a way that the insoluble protopectin is converted to soluble pectin, so that the de-esterified citrus fiber has about 35 wt% or less of water-soluble pectin.

This converted pectin is low methoxyl pectin due to the subsequent enzymatic de-esterification step. According to the invention, a low methoxyl pectin is a pectin which has a degree of esterification of less than 50%. The degree of esterification is the percentage of carboxylic groups in the galacturonic acid chains of the pectin which are present in esterified form, e. g. as methyl esters. The degree of esterification can be determined with the method according to JECFA (Monograph 19-2016, Joint FAO/WHO Expert Committee on Food Additives). The combination of de-pectinization and de-esterification thus yields the citrus fiber that can be used according to the invention, which is referred to in the context of the invention as “de-esterified citrus fiber”.

### The De-Esterified Apple Fiber

The activatable, de-esterified, pectin-converted apple fiber used according to the invention has a water-soluble pectin content of 5 wt% or more, the pectin having a degree of esterification of less than 50% and thus being a low methoxyl pectin. This activatable low methoxyl pectin-containing apple fiber is also briefly referred to as “de-esterified apple fiber” in the context of the invention. This de-esterified apple fiber is preferably obtainable by, or obtained by, the process described herein.

The de-esterified apple fiber used according to the invention advantageously has a water-soluble pectin content of between 5 wt% and 22 wt%, and particularly preferably between 8 and 15 wt%. The content of water-soluble pectin in the activatable, de-esterified, pectin-converted apple fiber can be, for example, 8 wt%, 9 wt%, 10 wt%, 11 wt%, 12 wt%, 13 wt%, 14 wt%, 15 wt%, 16 wt%, 17 wt%, 18 wt%, 19 wt%, 20 wt%, 21 wt% or 22 wt%.

The de-esterified apple fiber exhibits advantageous characteristics in terms of texturization and viscosification behavior, which can be read off from the yield point and dynamic Weissenberg number, respectively. Accordingly, the de-esterified apple fiber may exhibit one or more of the following characteristics with respect to yield point and dynamic Weissenberg number, and advantageously may satisfy all of these characteristics.

In one embodiment, the de-esterified apple fiber in a 2.5 wt% aqueous suspension has a yield point II (rotation) of greater than 0.1 Pa, advantageously greater than 0.6 Pa, and particularly advantageously of greater than 1.0 Pa.

In one embodiment, the de-esterified apple fiber in a 2.5 wt% aqueous suspension has a yield point II (cross over) of greater than 0.1 Pa, advantageously of greater than 0.4 Pa, and particularly advantageously of greater than 0.6 Pa.

In one embodiment, the de-esterified apple fiber in a 2.5 wt% aqueous dispersion has a yield point I (rotation) of greater than 1.0 Pa, advantageously of greater than 3.5 Pa, and particularly advantageously of greater than 5.5 Pa.

In one embodiment, the de-esterified apple fiber in a 2.5 wt% aqueous dispersion has a yield point I (cross over) of greater than 1.0 Pa, advantageously of greater than 4.0 Pa, and particularly advantageously of greater than 6.0 Pa.

Advantageously, the de-esterified apple fiber in a 2.5 wt% aqueous suspension has a dynamic Weissenberg number greater than 5.5, advantageously greater than 6.5, and particularly advantageously greater than 8.0.

Advantageously, the de-esterified apple fiber in a 2.5 wt% aqueous dispersion has a dynamic Weissenberg number greater than 6.0, advantageously greater than 7.0, and particularly advantageously greater than 8.5.

For the de-esterified apple fiber, the features of the above-described characteristics with respect to yield point and dynamic Weissenberg number may also be combined in any permutation, if desired. Thus, in a particular embodiment, the de-esterified apple fiber used according to the invention may have all the characteristics with respect to yield point and dynamic Weissenberg number, wherein said de-esterified apple fiber preferably is obtainable by the present process or obtained thereby.

To determine yield point I (rotation), yield point I (cross over), and dynamic Weissenberg number in a 2.5 wt% aqueous dispersion, the de-esterified apple fiber is dispersed as a 2.5 wt% aqueous solution according to the method disclosed in the examples, and the measurement is made after 1 h at 20° C.

To determine yield point II (rotation), yield point II (cross over) and dynamic Weissenberg number in a 2.5 wt% aqueous suspension, the de-esterified apple fiber is suspended as a 2.5 wt% aqueous solution according to the method disclosed in the examples, measurement is carried out after 1 h at 20° C.

In an advantageous embodiment, the de-esterified apple fiber has, in a 4 wt% aqueous suspension, a firmness of greater than 100 g, preferably of greater than 125 g, and particularly preferably of greater than 150 g.

According to a particular embodiment, the de-esterified apple fiber in a composition with 22°Brix and 2.5 wt% fiber concentration has a breaking strength of 50 HPE to 200 HPE, advantageously of 80 HPE to 170 HPE and even more advantageously of 110 HPE to 150 HPE. The comparatively high breaking strength is due to the low methoxyl pectin. For example, the breaking strength may be 80, 85, 90, 95, 100, 105, 110, 115, 120, 125, 130, 135, 140, 145, 150, 155, 160, 165, 170, 175, 180, 185, 190, 195 or 200 HPE for 2.5 wt% fiber concentration at 22°Brix.

According to a particular embodiment, the de-esterified apple fiber in a composition with 40°Brix and 2.5 wt% fiber concentration has a breaking strength of 180 HPE to 380 HPE, advantageously of 230 HPE to 330 HPE and even more advantageously of 250 HPE to 300 HPE. The comparatively high breaking strength is due to the low methoxyl pectin. For example, the breaking strength may be 230, 240, 250, 260, 270, 280, 290, 300, 310, 320, or 330 HPE for 2.5 wt% fiber concentration at 40°Brix.

According to the present invention, the term “breaking strength” is a measure of the strength of a gel prepared with sucrose in a buffer solution at pH about 3.0 and formed at 22°Brix or 40°Brix. The breaking strength is determined after cooling in a water bath at 20° C. for two hours. The breaking strength is determined using the Herbstreith Pektinometer Mark IV or an equivalent precursor model. The method used is hereinafter referred to as the breaking strength test, the measured value as the breaking strength, and the unit of measurement is Herbstreith Pektinometer Units (HPE).

Preferably, the de-esterified apple fiber has a viscosity of greater than 300 mPas, preferably of greater than 400 mPas, and particularly preferably of greater than 500 mPas, wherein the de-esterified apple fiber is dispersed in water as a 2.5 wt% solution and the viscosity is measured with a shear rate of 50 s⁻¹ at 20° C. For example, the de-esterified apple fiber may have a viscosity of 325, 350, 375, 400, 425, 450, 475, 500, 525, 550, 575, 600, 625, 650, 675, 700, 725, 750, 775, 800, 825, 850, 875, 900, 925, 950, 975 or 1000 mPas.

For determining viscosity, the apple fiber is dispersed in demineralized water with the method disclosed in the examples as a 2.5 wt% solution, and viscosity is determined at 20° C. and four shearing sections (first and third section = constant profile; second and fourth section = linear ramp; each measurement at a shearing speed of 50 s⁻¹) (rheometer; Physica MCR series, measuring bob CC25 [corresponding to Z3 DIN], Anton Paar company, Graz, Austria). The advantage of a de-esterified apple fiber with such a high viscosity is that a lower amount of fiber is necessary for thickening the final product. In addition, the fiber thus creates a creamy texture.

The de-esterified apple fiber advantageously has a water binding capacity of more than 22 g/g, preferably of more than 24 g/g, and particularly preferably of more than 26 g/g. Such an advantageously high-water binding capacity leads to a high viscosity and consequently also to a lower fiber consumption with a creamy texture.

According to one embodiment, the de-esterified apple fiber has a moisture of less than 15%, preferably less than 10% and particularly preferably less than 8%.

It is also preferable for the de-esterified apple fiber to have, in a 1.0% aqueous solution, a pH value of 3.0 to 7.0 and preferably of 4.0 to 6.0.

The de-esterified apple fiber advantageously has a particle size in which at least 90% of the particles are smaller than 450 µm, preferably smaller than 350 µm and particularly preferably smaller than 250 µm.

In one advantageous embodiment, the de-esterified apple fiber has a lightness value of L* > 60, preferably L* > 61 and particularly preferably L* > 62. This means that the apple fibers are virtually colorless and do not cause any significant discoloration of the products when used in food products.

Advantageously, the de-esterified apple fiber has a dietary fiber content of 80 to 95%.

Due to the acid disintegration, the pectin of the apple fiber has been altered in such a way that the insoluble protopectin is converted to soluble pectin, so that the de-esterified apple fiber has about 35 wt% or less of water-soluble pectin.

The pectin of the de-esterified apple fiber is low methoxyl pectin due to the enzymatic de-esterification step. According to the invention, a low methoxyl pectin is a pectin which has a degree of esterification of less than 50%. The degree of esterification is the percentage of carboxylic groups in the galacturonic acid chains of the pectin which are present in esterified form, e. g. as methyl esters. The degree of esterification can be determined with the method according to JECFA (Monograph 19-2016, Joint FAO/WHO Expert Committee on Food Additives). The combination of de-esterification and optionally upstream gentle partial extraction yields the apple fiber that can be used according to the invention, which is referred to in the context of the invention as “de-esterified apple fiber”.

### Production of the Activatable, De-Esterified, Pectin-Converted Fruit Fiber

The activatable, de-esterified, pectin-converted fruit fiber is preferably a de-esterified citrus fiber or a de-esterified apple fiber and is obtainable by a method comprising the following steps:
(a) providing a raw material which contains the cell wall material of an edible fruit, preferably a citrus fruit or an apple fruit;
(b) optionally disintegrating the raw material from step (a) with a partial pectin extraction from said raw material by incubation the raw material from step (a) in an aqueous suspension at a pH of 2.5 to 5.0 and subsequent separation of the partially de-pectinized material from the mixture;
(c) suspending the raw material from step (a) or the partially de-pectinized material from step (b) in an aqueous liquid and incubating said aqueous suspension at a pH of between 0.5 and 2.5 to obtain a partially-activated, pectin-converted fruit fiber, preferably a partially activated pectin-converted apple fiber having a water-soluble pectin content of 5 to 22 wt% or a partially activated pectin-converted citrus fiber having a water-soluble pectin content of 10 to 35 wt%;
(d) optional addition of an alkali, alkaline salt or alkaline buffer system to the aqueous suspension of step (c) to adjust the pH to between pH = 3.0 and pH = 9.0;
(e) de-esterification of the partially activated fiber suspension from step (c) or the pH-adjusted fiber suspension from step (d) by enzymatic treatment with pectin methyl esterase or acid de-esterification;
(f) washing the de-esterified activated fiber from step (e) at least twice with an organic solvent and subsequently separating the washed fiber respectively from the organic solvent;
(g) optionally additionally removing the organic solvent by contacting the washed fiber from step (f) with water vapor;
(h) drying the material from step (f) or (g), comprising drying at normal pressure or vacuum drying to obtain the activatable, de-esterified, pectin-converted fruit fiber.

A fruit fiber according to the invention is a plant fiber, i.e. a fiber isolated from a non-lignified plant cell wall and consists mainly of cellulose, and which is hereby isolated from a fruit. A fruit is understood herein to be the totality of the organs of a plant that arise from a flower, including both the classical fruit fruits and fruit vegetables.

In a preferred embodiment, said fruit fiber is selected from the group consisting of citrus fiber, apple fiber, sugar beet fiber, carrot fiber and pea fiber, wherein the plant fiber is preferably a fruit fiber and particularly preferably a citrus fiber or an apple fiber.

An “apple fiber” in the sense of the application is a component consisting mainly of fibers, which is isolated from a non-lignified cellular wall of an apple and consists mainly of cellulose. In a sense, the term “fiber” is a misnomer since macroscopically, the apple fibers do not appear as fibers but as a powdery product. Other components of the apple fiber are, among others, hemicellulose and pectin.

The apple fiber can be obtained from all cultivated apples (malus domesticus) known to the person skilled in the art. As starting material, advantageously processing residues of apples can be employed. The starting material may be apple peel, apple core, apple seeds, fruit flesh or a combination thereof. Preferably, apple pomace is used as the raw material, i. e. the press residues of apples, which typically also contain the above-mentioned components in addition to the peels.

A “citrus fiber” in the sense of the application is a component consisting mainly of fibers, which is isolated from a non-lignified cellular wall of a citrus fruit and consists mainly of cellulose. In a sense, the term “fiber” is a misnomer since macroscopically, the citrus fibers do not appear as fibers but as a powdery product. Other components of the citrus fiber are, among others, hemicellulose and pectin. The citrus fiber can advantageously be obtained from citrus pulp, citrus peel, citrus vesicle, segment membranes or a combination thereof.

For the production of a de-esterified citrus fiber, citrus fruits, and preferably processing residues of citrus fruits, can be employed as raw material. The raw material may be citrus peel (albedo and/or flavedo), citrus vesicles, segment membranes or a combination thereof. Preferably, citrus pulp is used as the raw material, i. e. the press residues of citrus fruits, which typically also contain the fruit flesh in addition to the peels.

All citrus fruits known to the skilled person can be used as citrus fruits in this context. The following are listed by way of example in a non-restrictive manner: Mandarin (Citrus reticulata), Clementine (Citrus × aurantium Clementine group, Syn. : Citrus clementina), Satsuma (Citrus xaurantium Satsuma group, Syn. : Citrus unshiu), Mangshan (Citrus mangshanensis), Orange (Citrus xaurantium orange group, Syn.: Citrus sinensis), Bitter Orange (Citrus xaurantium bitter orange group), Bergamot (Citrus ×limon bergamot group, Syn. : Citrus bergamia), grapefruit (Citrus maxima), grapefruit (Citrus ×aurantium grapefruit group, syn. : Citrus paradisi) pomelo (Citrus ×aurantium pomelo group), true lime (Citrus ×aurantiifolia), common lime (Citrus ×aurantiifolia, syn. Citrus latifolia), kaffir lime (Citrus hystrix), Rangpur lime (Citrus ×jambhiri), lemon (Citrus ×limon lemon group), citron (Citrus medica) and kumquats (Citrus japonica, Syn.: Fortunella). Preferred among these are orange (Citrus ×aurantium orange group, syn.: Citrus sinensis) and lemon (Citrus ×limon lemon group).

The optional acidic disintegration in step (b) of the method is used to partially remove pectin from the cellular network by converting a partial fraction of the protopectin into soluble pectin and at the same time activating the fiber by enlargement of the interior surface. Furthermore, the raw material is thermally comminuted by the disintegration. Due to acidic incubation in the aqueous environment, with the application of heat, it disintegrates into citrus fibers. In this way, thermal comminution is achieved; mechanical comminution is not necessary within the framework of this production method. This is a substantial advantage over conventional fiber production methods which, in contrast, require a shearing step (for instance [high] pressure homogenization) in order to obtain a fiber with sufficient rheological properties.

The acid disintegration in step (b) is such that the pectin extracted in the partial extraction is a high methoxyl pectin with high gelling strength and good viscosifying ability. It is therefore also referred to as “high quality pectin” in the context of the present application. The acid disintegration according to step (b) is a full pectin extraction in the sense that the pectin brought into solution is thereafter separated from the fiber material by solid-liquid separation.

The high quality pectin resulting from the partial extraction is a high methoxyl pectin. A high methoxyl pectin according to the invention is a pectin with a degree of esterification of at least 50%. The degree of esterification describes the percentage degree of carboxylic groups in the galacturonic acid units of the pectin which are present in esterified form, e. g. as methyl esters. The degree of esterification can be determined by the method according to JECFA (monograph 19-2016, Joint FAO/WHO Expert Committee on Food Additives).

According to an advantageous embodiment, the high-quality pectin, which is preferably a high methoxyl soluble citrus pectin or apple pectin, has a degree of esterification of from 50 to 80%, preferably from 60 to 80%, particularly preferably from 70 to 80%, and especially preferably from 72% to 75%. For example, the degree of esterification of the high methoxyl soluble pectin, which is preferably a high methoxyl soluble citrus pectin or apple pectin, may be 70%, 71%, 72%, 73%, 74%, 75%, 76%, 77%, 78%, 79% or 80%.

According to one embodiment, the high-quality pectin, which is preferably a high methoxyl soluble citrus pectin, has a viscosity, measured in mPas, of from 500 to 1500 mPas, preferably from 600 to 1400 mPas, more preferably from 700 to 1300 mPas, and especially preferably from 800 to 1200 mPas.

According to one embodiment, the high-quality pectin, which is preferably a high methoxyl soluble citrus pectin, has a gelling power, measured in °SAG, of from 150 to 300°SAG, preferably from 200 to 280°SAG, particularly preferably from 240 to 270°SAG, and especially preferably from 260 to 265°SAG. For example, the gelling power of the high methoxyl soluble pectin, which is preferably a high methoxyl soluble citrus pectin, may be 160, 170, 180, 190, 200, 210, 220, 230, 240, 250, 260, 261, 262, 263, 264, 265, 266, 267, 268, 269, 270, 280, 290, and 300°SAG.

According to a further embodiment, the high-quality pectin, which is preferably a high methoxyl soluble apple pectin, has a gelling power, measured in °SAG, of from 150 to 250°SAG, preferably from 170 to 240°SAG, particularly preferably from 180 to 220°SAG, and especially preferably from 190 to 200°SAG. For example, the gelling power of the high methoxyl soluble pectin, which is preferably a high methoxyl soluble apple pectin, may be 160, 170, 180, 190, 191, 192, 193, 194, 195, 196, 197, 198, 199, 200, 210, 220, 230 and 240°SAG.

During the disintegration according to step (b), the raw material is an aqueous suspension. A suspension according to the invention is a heterogeneous mixture of a liquid and solids (raw material particles) finely distributed therein. Since the suspension tends to sedimentation and separation of phases, the particles are suitably kept in suspension by shaking or stirring. That is, there is no dispersion, which would mean that the particles are mechanically comminuted (shearing) so as to be finely dispersed.

To achieve an acidic pH value in step (b), the person skilled in the art may employ all acids or acidic buffering solutions that are known to him. For example, an organic acid can be used that acts as a calcium chelator and can thus bind excess calcium ions. Examples of such a chelating acid are citric acid, gluconic acid or oxalic acid.

Alternatively, or in combination, a mineral acid may be used. Some examples are sulfuric acid, hydrochloric acid, nitric acid or sulfurous acid. Preferably, nitric acid or sulfuric acid is employed.

In the optional acidic disintegration in step (b), a complexing agent for divalent cations can also be added. Polyphosphates or EDTA are mentioned here as examples.

In acidic disintegration according to optional step (b) of the method, the pH value of the suspension is between pH = 2.5 and pH ═ 5.0, preferably between pH = 2.8 and pH = 4.5 and particularly preferably between pH = 3.0 and pH = 4.0. For example, the optional acidic disintegration can be performed at a pH of 2.8, 2.9, 3.0, 3.1, 3.2, 3.3, 3.4, 3.5, 3.6, 3.7, 3.8, 3.9, or 4.0.

Advantageously, the liquid for producing the aqueous suspension of the optional acidic disintegration in step (b) consists of more than 50 vol%, preferably more than 60, 70, 80 or even 90 vol%, of water. In a preferred embodiment, the liquid contains no organic solvent and in particular no alcohol. Thus, the process is a water-based acidic extraction.

In the optional acidic disintegration in step (b), the incubation takes place at a temperature of between 55° C. and 80° C., preferably of between 60° C. and 75° C., and particularly preferably of between 65° C. and 70° C. For example, the optional acidic disintegration can be performed at a temperature of 60° C., 61° C., 62° C., 63° C., 64° C., 65°°C, 66° C., 67° C., 68° C., or 69° C.

In the optional acidic disintegration in step (b), the incubation takes place over 60 min to 8 hours, and preferably over 2 to 6 hours. For example, the optional acidic disintegration can be performed over a period of 1.5 h, 2.0 h, 2.5 h, 3.0 h, 3.5 h, 4.0 h, 4.5 h, 5.0 h, 5.5 h or 6.0 h.

In acidic disintegration according to step (b), the aqueous suspension suitably has a dry mass of between 0.5 wt% and 20 wt% preferably of between 3 wt% and 16 wt%, and particularly preferably of between 5 wt% and 14 wt%. For example, the dry weight may be 1, 2, 3, 4, 5, 6, 7, 8, 9, 10, 11, 12, 13, 14, 15, or 16 wt% for the optional acidic disintegration.

During the disintegration in step (b), the aqueous suspension is suitably set in motion by the application of force, e.g. stirred or shaken. This is preferably done in a continuous manner so that the particles in the suspension are kept in suspension.

The acidic disintegration in step (c) of the method is used to convert protopectin into soluble pectin and at the same time activate the fiber by enlargement of the interior surface. The acid disintegration according to step (c) is not a functional pectin extraction. The solubilized pectin is not separated from the fiber material by solid-liquid separation, but remains in the suspension together with the partially activated fiber in the following process steps (d) and/or (e). Thus, in the final result, no pectin removal takes place, but a pectin conversion from protopectin to water-soluble fiber-associated pectin. The result is therefore an activatable, de-esterified, pectin-converted fiber.

Furthermore, the raw material is thermally comminuted by the disintegration. Due to acidic incubation in the aqueous environment, with the application of heat, it disintegrates into fruit fibers. In this way, thermal comminution is achieved; mechanical comminution is not necessary within the framework of this production method. This is a substantial advantage over conventional fiber production methods which, in contrast, require a shearing step (for instance [high] pressure homogenization) in order to obtain a fiber with sufficient rheological properties.

In case the material fed to the acidic disintegration according to step (c) has already been subjected to the optional acidic disintegration according to step (b), the acidic disintegration in step (c) can perform an additional pectin extraction by converting another part of the protopectin into soluble pectin and extracting it.

During the disintegration according to step (c), the raw material is an aqueous suspension. A suspension according to the invention is a heterogeneous mixture of a liquid and solids (raw material particles) finely distributed therein. Since the suspension tends to sedimentation and separation of phases, the particles are suitably kept in suspension by shaking or stirring. That is, there is no dispersion, which would mean that the particles are mechanically comminuted (shearing) so as to be finely dispersed.

To achieve an acidic pH value in step (c), the person skilled in the art may employ all acids or acidic buffering solutions that are known to him. For example, an organic acid can be used that acts as a calcium chelator and can thus bind excess calcium ions. Examples of such a chelating acid are citric acid, gluconic acid or oxalic acid.

Alternatively, or in combination, a mineral acid may be used. Some examples are sulfuric acid, hydrochloric acid, nitric acid or sulfurous acid. Preferably, nitric acid or sulfuric acid is employed. In the acidic disintegration in step (c), a complexing agent for divalent cations can also be added. Polyphosphates or EDTA are mentioned here as examples.

In acidic disintegration according to step (c) of the method, the pH value of the suspension is between pH = 0.5 and pH = 2.5, preferably between pH = 1.0 and pH = 2.3 and particularly preferably between pH = 1.5 and pH = 2.0. For example, the acidic disintegration according to step (c) can be performed at a pH of 0.5, 0.6, 0.7, 0.8, 0.9, 1.0, 1.1, 1.2, 1.3, 1.4, 1.5, 1.6 1.7, 1, 8, 1, 9, 2, 0, 2, 1, 2, 2, 2, 3, 2, 3, 2, 4 or 2.5.

Advantageously, the liquid for producing the aqueous suspension of the acidic disintegration in step (c) consists of more than 50 vol%, preferably more than 60, 70, 80 or even 90 vol%, of water. In a preferred embodiment, the liquid contains no organic solvent and in particular no alcohol. Thus, the process is a water-based acidic extraction.

In the acidic disintegration in step (c), the incubation takes place at a temperature of between 60° C. and 95° C., preferably of between 70° C. and 90° C., and particularly preferably of between 75° C. and 85° C. For example, the acidic disintegration according to step (c) can be performed at a temperature of 70° C., 71° C., 72° C., 73° C., 74° C., 75° C., 76° C., 77° C., 78° C., 79° C., 80° C., 81° C., 82° C., 83° C., 84° C. or 85° C.

In the acidic disintegration in step (c), the incubation takes place over 60 min to 8 hours, and preferably over 2 to 6 hours. For example, the optional acidic disintegration can be performed over a period of 1.5 h, 2.0 h, 2.5 h, 3.0 h, 3.5 h, 4.0 h, 4.5 h, 5.0 h, 5.5 h or 6.0 h.

In acidic disintegration according to step (c), the aqueous suspension suitably has a dry mass of between 0.5 wt% and 20 wt% preferably of between 3 wt% and 16 wt%, and particularly preferably of between 5 wt% and 14 wt%. For example, the dry weight may be 1, 2, 3, 4, 5, 6, 7, 8, 9, 10, 11, 12, 13, 14, 15, or 16 wt% for the optional acidic disintegration.

During the disintegration in step (c), the aqueous suspension is suitably set in motion by the application of force, e.g. stirred or shaken. This is preferably done in a continuous manner so that the particles in the suspension are kept in suspension.

In step (d) of the process, the addition of an alkali, an alkaline salt or a buffer system to the aqueous suspension from step (c) can optionally be carried out in order to set a pH value of between pH 3.0 and pH 9.0. This has the purpose of setting the optimum pH for the following de-esterification, which can be carried out either as enzymatic de-esterification or as acidic de-esterification.

For this pH adjustment, which is a pH increase starting from the strongly acidic pH of step (c), an alkali such as NaOH, KOH or an alkaline salt such as sodium carbonate, sodium hydrogen carbonate, potassium carbonate, or potassium hydrogen carbonate can be used. Alternatively, a buffer system, i.e. a mixture of a weak acid with its conjugate base, can be used that has a buffer range of between pH 3.0 and pH 9.0.

According to step (e), the activatable pectin-converted fiber suspension from step (c) or the pH-adjusted fiber suspension from step (d) is de-esterified, i.e. the esterified galacturonic acid groups of the pectin are hydrolyzed. This can be done on the one hand by enzymatic treatment with pectin methyl esterase (PME) or alternatively by acidic de-esterification.

For enzymatic de-esterification according to step (e), the fiber suspension is contacted with a pectin methyl esterase and incubated for a sufficient period of time.

The pectin methy lesterase hydrolyzes the methyl esters of the galacturonic acid groups in the pectin to form poly-galacturonic acid and methanol. The resulting low methoxyl pectins can form a gel in the presence of polyvalent cations even without sugar and can also be used in a wide pH range.

A pectin methyl esterase (abbreviation: PME, EC 3.1.1.11, also: pectin demethoxylase, pectin methoxylase) is a commonly found enzyme in the cell wall in all higher plants and some bacteria and fungi, which cleaves the methyl esters of pectins, forming poly-galacturonic acid and releasing methanol. PME has been isolated in many isoforms, all of which can be used for enzymatic de-esterification according to the invention. Thus, PME has been isolated in many isoforms from plant pathogenic fungi such as Aspergillus foetidus and Phytophthora infestans as well as from higher plants, e.g. tomatoes, potatoes and oranges. Fungal PMEs exhibit optimal activity between pH 2.5 and 5.5, whereas plant PMEs exhibit pH optima between pH 5 and 8. The relative molecular mass is between 33,000 and 45,000. The enzyme is present as a monomer and is glycosylated. The K_{M} value ranges from 11 to 40 mM pectin in fungal PME and from 4-22 mM pectin in plant PME. The commercially available preparations of PME are obtained either from the supernatants of fungal mycelial cultures or, in the case of plants, from fruits (peels of oranges and lemons, tomatoes). The preferred pectin methyl esterases have a pH optimum between 2 and 5 and a temperature optimum at 30 to 50° C., although depending on the enzyme, appreciable enzyme activity can be observed from as low as 15° C.

The following table shows some examples of commercially available PME with their reaction optima:

| | | |
|---|---|---|
| Product name | Manufacturer | Optima |
| Rapidase PEP | DSM | pH = 4 - 5; T = 50° C. |
| Pectinase 872 L | Biocatalysts | pH = 4 - 5; T = 30 - 50° C. |
| Pectinesterase 1508/14 | Erbslöh | pH = 4 - 5; T = 30 - 50° C. |

The duration of the incubation with the pectin methyl esterase is between 1 hour and 10 hours, preferably between 2 hours and 5 hours.

Due to the process steps carried out in advance, a suspension with a low dry substance content (< 20 %TS) is present. The enzyme treatment is then expediently carried out in a stirred tank.

### Acidic De-Esterification

During acidic de-esterification in step (e) of the process, the pH of the suspension is between pH = 1.0 and pH = 2.0. The acidic de-esterification according to step (e) can be carried out, for example, at a pH of 1.1, 1.2, 1.3, 1.4, 1.5, 1.6, 1.7, 1.8 or 1.9.

The acidic de-esterification according to step (e) is carried out at a temperature of between 30° C. and 60° C. For example, it can be carried out at a temperature of 35° C., 40° C., 45° C., 55° C. or 58° C.

In the acidic de-esterification according to step (e), the incubation is carried out for a period of between 30 min to 10 days and preferably between 2 h and 6 hours. For example, the acid digestion according to step (c) can be carried out over a time period of 1 h, 1.5 h, 2.0 h, 2.5 h, 3.0 h, 3.5 h, 4.0 h, 4.5 h, 5.0 h, 5.5 h or 6.0 h.

In step (f), a washing step is then performed with a washing liquid comprising a water-miscible organic solvent. This involves washing at least twice with the washing liquid comprising a water-miscible organic solvent.

A solvent means here at least one solvent, so that two, three or more water-miscible organic solvents may also be contained in the washing liquid.

The washing liquid in step (f) preferably comprises more than 70 vol%, particularly preferably more than 80 vol%, and especially preferably more than 85 vol% of the water-miscible organic solvent. For example, the washing liquid may comprise 80%, 81%, 82%, 83%, 84%, 85%, 86%, 87%, 88%, 89%, 90%, 91%, 92%, 93%, 94%, 95%, 96%, 97%, 98%, 99% or 99.5% of water-miscible organic solvent, the percentages representing volume percentages. In an alternative embodiment, the washing liquid comprises the organic water-miscible solvent.

The further ingredient which complements this organic water-miscible solvent to 100% is expediently water or an aqueous buffer.

Water-miscible, thermally stable, volatile solvents containing only carbon, hydrogen and oxygen, such as alcohols, ethers, esters, ketones and acetals, are particularly suitable for carrying out the present process. Preferably, ethanol, n-propanol, isopropanol, methyl ethyl ketone, 1,2-butanediol-1-methyl ether, 1,2-propanediol-1-n-propyl ether or acetone are used.

An organic solvent is described as “water-miscible” if it is present as a single-phase liquid in a 1:20 (v/v) mixture with water.

In general, expediently solvents are used which are at least 10% water-miscible, have a boiling point below 100° C. and/or fewer than 10 carbon atoms.

The water-miscible organic solvent as a component of the washing liquid is preferably an alcohol, advantageously selected from the group consisting of methanol, ethanol and isopropanol. In a particularly preferred manner, it is isopropanol.

The washing step in step (f) is carried out at a temperature of between 40° C. and 75° C., preferably of between 50° C. and 70° C. and particularly preferably of between 60° C. and 65° C.

The contacting with the washing liquid containing the water-miscible organic solvent in step (f) takes place over a period of time of between 60 min and 10 h, and preferably between 2 h and 8 h.

Each washing step with the washing liquid containing a water-miscible organic solvent comprises bringing the material into contact with the washing liquid for a certain period of time followed by separation of the material from the washing solution as a mixture of washing liquid and pre-existing liquid (as part of the suspension). A decanter or a press is preferably used for this separation.

In the washing according to step (f) with a washing liquid containing a water-miscible organic solvent, the dry mass in the washing solution is from between 0.5 wt% and 15 wt%, preferably between 1.0 wt% and 10 wt%, and particularly preferably between 1.5 wt% and 5.0 wt%.

The washing according to step (f) with the washing liquid containing a water-miscible organic solvent is preferably carried out with mechanical agitation of the washing mixture. Preferably, the washing is carried out in a vessel with a stirrer.

In the washing according to step (f) with the washing liquid containing a water-miscible organic solvent, advantageously a device for homogenization of the suspension is used. This device is preferably a toothed ring disperser.

According to an advantageous embodiment, washing with the washing liquid containing a water-miscible organic solvent in step (f) takes place in a counterflow procedure.

In one embodiment, partial neutralization by addition of Na or K salts, NaOH or KOH, takes place during washing with the washing liquid containing a water-miscible organic solvent in step (f) with the organic solvent.

During washing with the washing liquid containing a water-miscible organic solvent in step (f), decoloring of the material can also be performed. This decoloring may take place by the addition of one or more oxidants. For instance, the oxidants could be chlorine dioxide and hydrogen peroxide, which may be used by themselves or in combination.

In an advantageous embodiment, during the at least two-fold washing with the washing liquid containing a water-miscible organic solvent in step (f), the concentration of the organic solvent in the solution increases with each washing step. By this incremental increase in organic solvent, the portion of water in the fiber material is reduced in a controlled manner such that the rheological properties of the fibers are maintained during the subsequent steps of solvent removal and drying, and the activated fiber structure does not collapse.

Preferably, the final concentration of the water-miscible organic solvent amounts to between 60 and 70 vol% in the first washing step, between 70 and 85 vol% in the second washing step, and in an optional third washing step, between 80 and 90 vol% of the complete washing solution (i.e. the fiber suspension with the added washing liquid).

According to one embodiment, when washing at least twice in step (f) with the washing liquid containing the organic water-miscible solvent, this washing liquid may have an acidic pH in the first washing step, preferably between pH 0.5 and pH 3.0. This acidic pH also washes calcium ions out of the fiber.

In such a case, it is preferred that a second washing step has a weakly acidic to weakly alkaline pH, so that the fiber obtained is preferably between pH 4.0 and pH 6.0. The less acidic pH value ensures that the solubility of the pectin is improved and that in the final application the pH value typical for a foodstuff is not shifted too much in the direction of an acidic pH.

According to the optional step (g), the solvent content can additionally be reduced by contacting the material with water vapor. This is preferably done by means of a stripper in which the material is contacted with water vapor as the stripping gas in countercurrent.

In an advantageous embodiment, the material is moisturized with water after step (f) or (g) before drying. This is preferably done by introduction of the material in a moisturization screw and spraying with water.

In step (h), the washed material from step (f) or the stripped material from step (g) are dried, wherein the drying process comprises drying at normal pressure or vacuum drying.

Examples of suitable drying methods are fluid bed drying, fluidized-bed drying, belt drying, drum drying or paddle drying. Fluidized-bed drying is particularly preferred. The advantage is that the product is dried in a loose condition which simplifies the subsequent comminution step. In addition, this type of drying avoids damage to the product by local overheating since the input of heat can be dosed very well.

Drying under normal pressure in step (i) expediently takes place at a temperature between 50° C. and 130° C., preferably between 60° C. and 120° C. and particularly preferably between 70° C. and 110° C. After drying, the product is advantageously cooled to ambient temperature.

In an alternative embodiment the drying process according to step (h) comprises vacuum drying and preferably consists of vacuum drying. During vacuum drying, the washed material as drying material is subjected to a vacuum, which lowers the boiling point, thus leading to evaporation of the water even at low temperatures. The evaporation heat, which is continuously lost by the drying material, is suitably restored from outside up to constant temperature. The effect of vacuum drying is that it lowers the equilibrium vapor pressure, promoting capillary transport. This has in particular been proven advantageous for the present apple fiber material since in this manner the activated open fiber structures and the resulting rheological properties are maintained. Preferably, vacuum drying takes place at a negative pressure of less than 400 mbar, preferably less than 300 mbar, further preferably less than 250 mbar and particularly preferably less than 200 mbar.

Drying under vacuum in step (h) advantageously takes place at a shell temperature of between 40° C. and 100° C., preferably between 50° C. and 90° C. and particularly preferably between 60° C. and 80° C. After drying, the product is advantageously cooled to ambient temperature.

In an advantageous embodiment, the method additionally comprises a comminution, milling or sieving step after drying in step (h). This step is advantageously performed such that as a result, 90% of the particles have a size of less than 450 µm, preferably less than 350 µm and in particular less than 250 µm. At this particle size, the fiber is well dispersible and has optimum swelling properties.

The activatable, de-esterified, pectin-converted fruit fiber used according to the invention, as well as a method to the production thereof, are disclosed in the application DE 10 2020 120 606.2.

In one embodiment, the activatable, de-esterified, pectin-converted fruit fiber can be used for manufacturing of a food product. This can be any food product known to the person skilled in the art. Advantageously, the food product is selected from the group consisting of preserved products, deep-frozen foods, vegan food, vegetarian food, gluten-free food, low-calorie food, low-sugar food, lactose-free food, jelly, jelly-type sweets, sauce, granola bars, fruit pieces, fruit snacks, fruit bars, milk substitute drink, milk substitute product, foam sugar products, sherbet, ice cream, desserts, fermented drink, milk product, delicacies, fruit drink, fruit drink containing alcohol, cocktail, vegetable drink, chutney, barbecue sauce, smoothies, instant drink, fruit spread, fruit compote, fruit dessert, fruit sauce, fruit preparations, bake-stable fruit preparations, fruit preparations for yoghurt, bake-stable vegetable preparations, bake-stable fatty fillings, baked goods, pasta and pasta fillings, noodle dishes, potato snack, cheese and cream cheese preparations, meat substitute products, extruder products, corn flakes, breakfast cereals, soup, sauce, mayonnaise, meats, sausages, sausage casings, seafood, spirits, lozenges, functional food, nutritional supplements and dietary foods such as enteral foods, dysphagia food or sip feed.

In the food area, the activatable, de-esterified, pectin-converted fruit fiber is especially suited for textured products. For further optimization, it can be combined here with hydrocolloids and/or functional dietary fibers.

In milk substitution drinks, such as, for example, almond milk, it has been shown that the activatable, de-esterified, pectin-converted fruit fiber can increase stability and in particular contribute to turbidity stabilization. Additionally, the activatable, de-esterified, pectin-converted fruit fiber can here increase viscosity, act as a good emulsifier and help to improve flavor release.

The use of the activatable, de-esterified, pectin-converted fruit fiber in milk substitution products and milk products can provide the following advantages: increased stability, turbidity stabilization, better emulsification, better mouthfeel, texturing, reduction of nutritional value, increased creaminess, substitution of emulsifying salts, reduction of syneresis, improved spreadability and fat substitution.

Selected milk substitution products or milk products are, for example, desserts, yoghurt, yoghurt drink, non-fermented products, fermented drinks, fermented products, processed cheese, cream cheese products.

The use of the activatable, de-esterified, pectin-converted fruit fiber in ice cream or frozen desserts can provide the following advantages: retardation of crystal growth, form stability in case of heating, improvement of melting behavior, fat substitution, increased creaminess, better mouthfeel, optimization of nutritional value, improved flavor release.

The ice cream or frozen dessert can here contain alcohol or not, be fat-free or high in fat content; it may contain insect protein, milk or milk components or even, as vegan ice cream, be free of animal protein. The ice cream or frozen dessert may also be fruit-and/or vegetable-based.

The use of the activatable, de-esterified, pectin-converted fruit fiber in sweets and especially in chewing gum articles can provide the following advantages: improved abrasive behavior, water retention and improved flavor release.

The use of the activatable, de-esterified, pectin-converted fruit fiber in sweets and especially in chocolate products can provide the following advantages: fat substitution, processing aid, process stability, better emulsification and thus reduction of grease leak, better viscosity, texturing, optimization of nutritional value (e. g. by reduction in sugar).

The use of the activatable, de-esterified, pectin-converted fruit fiber in sweets and especially in jelly-type products can provide the following advantages: texturing, improved gelling, adaptation of viscosity, process optimization, reduction in stickiness and better processing.

Some examples of respective sweets are: fruit pieces, jelly products with different Brix values, jelly products containing fruit, jelly products containing vegetables, these jelly products in combination with nuts or nut derivatives, and sweet confectionary fillings.

The use of the activatable, de-esterified, pectin-converted fruit fiber in fruit- and/or vegetable-containing drinks potentially containing additional products such as cereals, nuts etc. can provide the following advantages: increased stability, turbidity stability, good emulsification of juices, better mouthfeel, texturing and reduction in nutritional value.

The fruit- and/or vegetable-containing drink can comprise a large range in terms of viscosity, ranging from thin-flowing to spoonable. In addition to sugary drinks, drinks which are reduced in sugar, sugar-free or salty can also be used. Smoothies are preferred.

The use of the activatable, de-esterified, pectin-converted fruit fiber in bake-stable fillings can provide the following advantages: form stability, reduction in syneresis, easy introduction, enhanced processing. Advantageously, the activatable, de-esterified, pectin-converted fruit fiber can be employed for fillings with a low Brix value of 30-45% dry matter or even lower.

The bake-stable fillings can be fillings containing fruit, vegetables, chocolate, nuts, cereals, cheese or any combination thereof.

The use of the activatable, de-esterified, pectin-converted fruit fiber in deep-frozen products, and in particular deep-frozen bakery products, can provide the following advantages: enhanced stability of deep-frozen bakery products in terms of loss of volume over storage time, network stabilization, support of gelling in the bakery product and support of gluten network stability.

The use of the activatable, de-esterified, pectin-converted fruit fiber in baked goods can provide the following advantages: improved elasticity of dough, prolonged freshness, delayed retrogradation, reduction of surface stickiness, improved machine runability (e. g. in case of rye and spelt), optimization of break stability, maintaining of crispness, enhancement of yield of dough and reduction of pastry loss.

The use of the activatable, de-esterified, pectin-converted fruit fiber in sprinkled baked goods can provide optimized adhesion to e. g. cereals, spices or the like. This applies to frozen and non-frozen products.

The use of the activatable, de-esterified, pectin-converted fruit fiber in gluten-free baked goods can provide the following advantages: improved elasticity of dough, prolonged freshness, delayed retrogradation, reduction of surface stickiness, improved machine runability, optimization of break stability, maintaining of crispness, enhancement of yield of dough, reduction of pastry loss. The activatable, de-esterified, pectin-converted fruit fiber here provides a substantial contribution to viscosity build-up. It also supports the starch network.

The use of the activatable, de-esterified, pectin-converted fruit fiber in extrudates can provide the following advantages: support of extrudability, improved volume result, fine pore structure. This applies to a broad spectrum of extruded products, such as e. g. cereal, fruit, vegetable, protein or meat extrudates.

The use of the activatable, de-esterified, pectin-converted fruit fiber in meat substitutes based on plant proteins can provide the following advantages: enhanced form stability, enhanced water retention, enhanced emulsification, advantageous texturing, bite optimization, stabilization of matrix, improved cohesion.

The use of the activatable, de-esterified, pectin-converted fruit fiber in savory products can provide the following advantages: reduction of syneresis, advantageous texturing, stabilization, easy introduction, good form stability, maintaining/support of the typical structure.

The use of the activatable, de-esterified, pectin-converted fruit fiber in soups or sauces can provide the following advantages: spillover protection due to gelation at respective temperatures, fusion at respective temperatures, optimum gelling; better mouthfeel, good emulsification, stabilization, advantageous texturing.

The use of the activatable, de-esterified, pectin-converted fruit fiber in products based on insects or insect proteins can provide the following advantages: better form stability, enhanced water retention, enhanced emulsification, advantageous texturing, bite optimization, stabilization of matrix, improved cohesion.

The use of the activatable, de-esterified, pectin-converted fruit fiber in meat and sausage products can provide the following advantages: reduction or substitution of added salts (e.g. phosphates), increased water binding, enhanced emulsification, optimization of cutting properties, enhancement of elasticity, increased water retention, delayed drying on the surface, fat substitution, optimization of nutritional value (e. g. by fat or salt reduction).

The use of the activatable, de-esterified, pectin-converted fruit fiber in products containing alcohol can provide the following advantages: stabilization at alcohol contents to be defined, good viscosity adjustment, enhanced emulsification, good water binding, better mouthfeel and increased creaminess. These products can comprise a broad spectrum, from spirits such as liqueurs and jellies containing alcohol down to fillings containing alcohol.

The use of the activatable, de-esterified, pectin-converted fruit fiber in instant products can provide the following advantages: good carrier substance or good separating agent between the functional components, good viscosity build-up in cold or hot media, enhanced emulsification, advantageous texturing, stabilization and good dispersibility.

The use of the activatable, de-esterified, pectin-converted fruit fiber in artificial, i. e. in particular plant-based casings, can provide the following advantages: softer casing, optimized elasticity, good coating of the casings. Here, a combination with pectin is advantageous.

The use of the activatable, de-esterified, pectin-converted fruit fiber in dietary foods and in particular enteral feeding can provide the following advantages: good viscosity and ductility, easy swallowing of the food, homogeneous distribution of the agents contained.

The use of the activatable, de-esterified, pectin-converted fruit fiber in nutritional supplements can provide the following advantages: good viscosity, increase in dietary fiber content, stabilization, advantageous mouthfeel, fat substitute, good texturing, good emulsification.

The activatable, de-esterified, pectin-converted fruit fiber used according to the invention can be used as a foaming agent or whipping agent for foam stabilization. The possible advantages are: increased stability, enhanced formation and stability of emulsions, better mouthfeel, texturing, reduction in nutritional value, increased creaminess, enhanced spreadability, fat substitute, optimized destabilization of fat agglomerates.

Selected products for this type of use are foamed desserts (milk-or non-milk-based), cream, Froop® (creamy yoghurt with top layer of fruit puree) and ice cream.

The activatable, de-esterified, pectin-converted fruit fiber used according to the invention can be employed as an emulsifier. The possible advantages include: improved gloss, better mouthfeel, fat substitute, increased creaminess, no over-emulsification, better formation and stability of emulsions, optimization of nutritional value, texturing, stabilization and optimization of yield point. The activatable, de-esterified, pectin-converted fruit fiber can here be used for emulsions with a great variety of fat contents: from fat-free emulsions up to 80% of fat content.

The activatable, de-esterified, pectin-converted fruit fiber used according to the invention can be used as a carrier substance. For instance, it can be a carrier of active agents, flavors or colors.

The activatable, de-esterified, pectin-converted fruit fiber used according to the invention can be employed as a separating agent or free flow enhancer. It forms a protective layer between hygroscopic surfaces. Here, ease of use is advantageous.

The activatable, de-esterified, pectin-converted fruit fiber used according to the invention can be employed for manufacturing textile fibers and thus, textiles.

In one embodiment, the activatable, de-esterified, pectin-converted fruit fiber can be used for producing feedstuff. The person skilled in the art can employ all types of feedstuff known to him as products. Advantageously, the feedstuff is selected from the group consisting of feedstuff rich in starches, oleaginous feedstuff, feedstuff rich in protein, extrudate feedstuff, wet feed, binder, bird feedstuff rod, rodent feedstuff rod, fish bait, supplement feedstuff, feedstuff for particular nutritional purposes and dietary feedstuff.

The use of the activatable, de-esterified, pectin-converted fruit fiber in feedstuff in the form of wet feed can provide the following advantages: good texturing and structuring, good emulsification, stabilization, enhanced flavor release and optimization of nutritional value.

The use of the activatable, de-esterified, pectin-converted fruit fiber in feedstuff in the form of extrudates can provide the following advantages: finer pore structure and better volume result.

In one embodiment, the activatable, de-esterified, pectin-converted fruit fiber can be used for the production of animal supplies. The person skilled in the art can employ all types of animal supplies known to him as products. Advantageously, the animal supply is an animal bedding.

The use of the activatable, de-esterified, pectin-converted fruit fiber in animal bedding can provide the following advantages: high water absorption capacity and good retention.

In one embodiment, the activatable, de-esterified, pectin-converted fruit fiber can be employed for producing a hygiene article. Here, the person skilled in the art can use all hygiene articles known to him as products. Advantageously, the hygiene article is selected from the group consisting of wet wipes, diapers, incontinence articles such as protective trousers or incontinence pants, sanitary towels, tampons, panty liners and softcups.

The use of the activatable, de-esterified, pectin-converted fruit fiber in products such as wet wipes can result in good water binding and good water retention capability.

In one embodiment, the activatable, de-esterified, pectin-converted fruit fiber can be employed for producing a personal care product. The person skilled in the art can use all personal care products known to him as products. Advantageously, the personal care product is selected from the group consisting of soap, shower gel, bath additives, skin creams, lotions, gel, sunscreen, sun cream, repellent, shaving cream, shaving soap, epilator cream, toothpaste, dentition adhesive medium, shampoo, hair forming agents, hair-setting products, hair colorants, facial make-up, eye care products, lip care products, nail polish and self-tanning agents.

The use of the activatable, de-esterified, pectin-converted fruit fiber in products such as toothpaste, dentition adhesive medium or casting compounds can provide the following advantages: good abrasiveness, good adhesion, smooth and soft mouthfeel, good emulsification, targeted viscosity formation, stabilization, control of gelling speed.

The use of the activatable, de-esterified, pectin-converted fruit fiber in products such as shampoos or creams can result in vitalization, moisture-stabilizing effect on the skin (delayed drying out) and good skin tolerability.

The use of the activatable, de-esterified, pectin-converted fruit fiber in liquid-absorbing products such as diapers, incontinence articles like protective trousers or incontinence pants, sanitary towels, tampons, panty liners and softcups, can provide the following advantages: high water absorption capability and good retention.

In one embodiment, the activatable, de-esterified, pectin-converted fruit fiber can be used for producing a cleaning agent. Here, the person skilled in the art can use all cleaning agents known to him as products. Advantageously, the cleaning agent is selected from the group consisting of detergent, bile soap, washing-up liquid, dishwasher detergent, rinsing agent, neutral cleaner, abrasive cleaner, window cleaner, lime remover, drain cleaner, brake cleaner, alcohol cleaner, all-purpose cleaner, glass cleaner, sanitary cleaner, toilet cleaner, toilet gel, toilet soap, carpet cleaner, car care material, oven cleaner, bathroom cleaner and metal polish, shoe polish, oil absorbing and anti-dust agent.

The use of the activatable, de-esterified, pectin-converted fruit fiber in detergents can provide the following advantages: good adhesion to the toilet wall, good and stable gelling, advantageous abrasiveness, good solubility.

The use of the activatable, de-esterified, pectin-converted fruit fiber in toilet gels or toilet soaps can provide the following advantages: as a separating agent, a good separation of the functional components and homogeneous distribution of the abrasive components and agents.

The use of the activatable, de-esterified, pectin-converted fruit fiber in liquid detergents, and in particular in washing-up liquids, can provide the following advantages: as a separating agent, a good separation of the functional components and homogeneous distribution of the abrasive components and agents; good emulsification.

The use of the activatable, de-esterified, pectin-converted fruit fiber in shoe polish can provide the following advantages: good and stable emulsification, advantageous texturing.

In one embodiment, the activatable, de-esterified, pectin-converted fruit fiber can be employed for producing a coating agent. The person skilled in the art can use all coating agents known to him as products. Advantageously, the coating agent is selected from the group consisting of antistatic coating, oil-repellent coating and anti-block coating.

In one embodiment, the activatable, de-esterified, pectin-converted fruit fiber can be employed for producing an explosive. The person skilled in the art can use all explosives known to him as products. Advantageously, the explosive is a gelatinous explosive.

The activatable, de-esterified, pectin-converted fruit fiber can be employed as a separating agent in the explosive. It can reduce hygroscopicity, control gelation and facilitate processing.

In one embodiment, the activatable, de-esterified, pectin-converted fruit fiber can be employed for producing a lubricant. The person skilled in the art can use all lubricants known to him as products. Advantageously, the lubricant is selected from the group consisting of liquid lubricants, such as lubricating oil and cooling lubricant, lubricating grease and solid lubricant.

The use of the activatable, de-esterified, pectin-converted fruit fiber in a lubricant can provide the following advantages: targeted control of viscosity and yield point, stabilization of the emulsion.

The use of the activatable, de-esterified, pectin-converted fruit fiber in a coolant can provide the following advantages: targeted control of viscosity and yield point, and thus optimized energy absorption for improving cooling capacity.

In one embodiment, the activatable, de-esterified, pectin-converted fruit fiber can be employed for producing a plastic product. The person skilled in the art can use all plastic products known to him as products. Advantageously, the plastic product is a citrus fiber-reinforced plastic or a wood-plastic composite (WPC) .

Production of an alternative plastic product is advantageously performed by production of a compacted product. In this manner, flowerpots, straws or pallets, for example, can be produced.

In one embodiment, the activatable, de-esterified, pectin-converted fruit fiber can be employed for production of a varnish. The person skilled in the art can use all varnishes known to him as products. Advantageously, the varnish is selected from the group consisting of alkyd resin varnish, oil varnish, cellulose nitrate varnish, bitumen varnish, tar-containing varnish, phenolic resin varnish, urea resin varnish, melamine resin varnish, polyester varnish, epoxy resin varnish, polyurethane resin varnish, acrylic varnish and powder varnish.

In one embodiment, the activatable, de-esterified, pectin-converted fruit fiber can be employed for production of a coating agent. Here, the person skilled in the art can use all coating agents known to him as products. Advantageously, the coating agent is selected from the group consisting of glaze, oil paint, dispersion paint, chalk paint, silicate paint and liquid plaster.

The use of the activatable, de-esterified, pectin-converted fruit fiber in coating agents can provide the following advantages: targeted adjustment of viscosity, good emulsion stabilization and adjustment of yield point, better material adhesion, enhanced processability, e. g. in terms of spreadability or sprayability.

In one embodiment, the activatable, de-esterified, pectin-converted fruit fiber can be employed for production of a construction material. The person skilled in the art can use all construction materials known to him as products. Advantageously, the construction material is selected from the group consisting of building foam, sound proofing material, insulation material, concrete, screed, mortar, cement, chemical bonded anchors, chemical anchor bolts, asphalt and whisper asphalt.

The addition of the activatable, de-esterified, pectin-converted fruit fiber to an asphalt mixture results in the formation of a low-noise “whisper asphalt”.

The addition of the activatable, de-esterified, pectin-converted fruit fiber to construction materials such as concrete, screed, mortar or cement of an asphalt mixture can lead to controlled drying, reduction in the formation of cracks, optimized long-time durability and control of hardening.

The addition of the activatable, de-esterified, pectin-converted fruit fiber to a sound proofing material or an insulation material can stabilize the matrix and reduce the transmission of heat and sound.

In case of a building foam, the activatable, de-esterified, pectin-converted fruit fiber can stabilize the foam, thus advantageously influencing the matrix structure.

In one embodiment, the activatable, de-esterified, pectin-converted fruit fiber can be employed for producing an adhesive. The person skilled in the art can use all adhesives known to him as products. Advantageously, the adhesive is selected from the group consisting of dispersion adhesive, melt adhesive, plastisol, cyanoacrylate adhesive, methyl methacrylate adhesive, unsaturated polyester adhesive, epoxy adhesive, polyurethane adhesive, silicones, phenolic resin adhesive, polyimide adhesive, polysulfide adhesive, bismaleimide adhesive, adhesive based on silane-modified polymers, silicone adhesive and paste.

In adhesives, and in particular in paste, the activatable, de-esterified, pectin-converted fruit fiber can help to control viscosity in a targeted manner and to improve spreadability.

In one embodiment, the activatable, de-esterified, pectin-converted fruit fiber can be used for production of a medical product. The person skilled in the art can use all medical products known to him as products. Advantageously, the medical product is selected from the group consisting of powder, juice, lotion, ointment, cream, gel, tablet and rubber article.

The use of the activatable, de-esterified, pectin-converted fruit fiber in ointments can provide the following advantages: good control of viscosity, good formability, easy swallowing, increased creaminess, homogeneous distribution of agents, good drying, increased stabilization, good emulsification and good skin compatibility.

In one embodiment, the activatable, de-esterified, pectin-converted fruit fiber can be used for production of a medical product. The person skilled in the art can use all known medical products as products. Advantageously, the medical product is selected from the group consisting of wound dressing, emergency bandage, transdermal patch, stoma product and dental casting compound.

The use of the activatable, de-esterified, pectin-converted fruit fiber in patches can provide the following advantages: good gelling and water absorption with retention of the absorbed liquid. This results in moisture-stabilizing patches.

The use of the activatable, de-esterified, pectin-converted fruit fiber in stoma products, such as colostomy bags, can provide the following advantages: good water absorption and water binding with retention of the absorbed liquid, good skin compatibility.

In one embodiment, the activatable, de-esterified, pectin-converted fruit fiber can be used for production of a battery. The person skilled in the art can use all batteries known to him as products. Advantageously, the battery is selected from the group consisting of primary cell, accumulator and solid cell battery.

In one embodiment, the activatable, de-esterified, pectin-converted fruit fiber can be employed in the construction area. Advantageously, the use in road and path construction, masonry construction, concrete construction and reinforced concrete construction is comprised.

In one embodiment, the activatable, de-esterified, pectin-converted fruit fiber can be employed in extraction by drilling boreholes. Usage as addition to drilling fluid or fracfluid is advantageous.

The use of the activatable, de-esterified, pectin-converted fruit fiber in a drilling fluid or a fracfluid can provide the following advantages: increased viscosity in “drilling mud” or similar drilling liquids, replacement of the oil by medium with higher viscosity, targeted adjustment of viscosity, oil binding, good emulsification. As a result, the activatable, de-esterified, pectin-converted fruit fiber can thus be used as an extraction aid in the mining industry.

In one embodiment, the activatable, de-esterified, pectin-converted fruit fiber can be employed in agriculture. The usage in fertilizers, humectants, soil conditioners, plant substrates, flowerpots or substrate-tablet extrudates is advantageous.

In one embodiment, the activatable, de-esterified, pectin-converted fruit fiber can be employed for producing a fertilizer. The person skilled in the art can use all fertilizers known to him as products. Advantageously, the fertilizer is a binder for fertilizer cones.

The use of the activatable, de-esterified, pectin-converted fruit fiber in the production of fertilizers can help to keep the agents suspended and to control viscosity and yield point in a targeted manner.

In a substrate-tablet extrudate, the activatable, de-esterified, pectin-converted fruit fiber can serve as a carrier and/or a separating agent. The pectin can be detached from the fibers and release the nutrients in an ordered manner. In can also support moisturization.

In one embodiment, the activatable, de-esterified, pectin-converted fruit fiber can be employed as a reinforcing agent for producing a composite material. The person skilled in the art can use all composite materials known to him as products. Advantageously, the activatable, de-esterified, pectin-converted fruit fiber is employed for targeted control of abrasive properties, here as a substitute for microplastics.

As an alternative, the activatable, de-esterified, pectin-converted fruit fiber can be used for surface treatment of the composite materials.

The use of the activatable, de-esterified, pectin-converted fruit fiber in the production of a composite material can optimize durability and lead to improved elasticity.

In the previously taught uses, the activatable, de-esterified, pectin-converted fruit fiber is preferably a de-esterified citrus fiber or a de-esterified apple fiber.

In a further aspect, the invention relates to a product selected from the group consisting of food products, feeding stuff, commodity goods, animal need, hygiene products, personal care products, cleaning agents, coating agents, care agents, explosives, lubricants, cooling agents, plastic products, fabrics, imitation leather, varnish, ink, paints, building materials, composite materials, paper, cardboard, adhesives, fertilizers, drugs, medical products, batteries, wherein the product comprises the activatable, de-esterified, pectin-converted fruit fiber. Here, the activatable, de-esterified, pectin-converted fruit fiber is preferably a de-esterified citrus fiber or a de-esterified apple fiber.

In one embodiment, the product contains a portion of 0.05 wt% and 90 wt%, preferably between 0.1 and 50 wt%, particularly preferably from 0.1 to 25 wt% and especially preferably between 0.5 and 10 wt%, of the activatable, de-esterified, pectin-converted fruit fiber. For instance, the portion of the activatable, de-esterified, pectin-converted fruit fiber may be 1.0%, 1.25%, 1.5%, 1.75%, 2.0%, 2.25%, 2.5%, 2.75%, 3.0%, 3.25%, 3.5%, 3.75%, 4.0%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, 69%, 70%, 71%, 72%, 73%, 74%, 75%, 76%, 77%, 78%, 79%, 80%, 81%, 82%, 83%, 84%, 85%, 86%, 87%, 88% or 89%, wherein these are percentages by weight. Here, the activatable, de-esterified, pectin-converted fruit fiber is preferably a de-esterified citrus fiber or a de-esterified apple fiber.

### Definitions

A fruit fiber according to the application is a plant fiber, i.e. a fiber, which is isolated from a non-lignified plant cellular wall and consists mainly of cellulose, and which is here isolated from a fruit. A fruit in this context is understood to mean the entirety of the organs of a plant that arise from a flower, and includes both the classical fruit fruits and fruit vegetables.

An “apple fiber” in the sense of the application is a component consisting mainly of fibers, which is isolated from a non-lignified cellular wall of an apple and consists mainly of cellulose. In a sense, the term “fiber” is a misnomer since macroscopically, the apple fibers do not appear as fibers but as a powdery product. Other components of the apple fiber are, among others, hemicellulose and pectin.

The apple fiber can be obtained from all cultivated apples (malus domesticus) known to the person skilled in the art. As starting material, advantageously processing residues of apples can be employed. The starting material may be apple peel, apple core, apple seeds, fruit flesh or a combination thereof. Preferably, apple pomace is used as the raw material, i. e. the press residues of apples, which typically also contain the above-mentioned components in addition to the peels.

A “citrus fiber” in the sense of the application is a component consisting mainly of fibers, which is isolated from a non-lignified cellular wall of a citrus fruit and consists mainly of cellulose. In a sense, the term “fiber” is a misnomer since macroscopically, the citrus fibers do not appear as fibers but as a powdery product. Other components of the citrus fiber are, among others, hemicellulose and pectin. The citrus fiber can advantageously be obtained from citrus pulp, citrus peel, citrus vesicle, segment membranes or a combination thereof.

An activatable, de-esterified, pectin-converted citrus fiber according to the present application is defined by a content of water-soluble pectin of 10 to 35 wt%, wherein this pectin is a low methoxyl pectin.

An activatable, de-esterified, pectin-converted apple fiber according to the present application is defined by a content of water-soluble pectin of 5 to 22 wt%, wherein this pectin is a low methoxyl pectin.

Within the context of the invention, a “fatty cream” is understood to be a cream containing cooking oil and/or cooking fat. Cooking fats and cooking oil are lipids suitable for human consumption and having a neutral or characteristic smell and flavor. The substances are either called “cooking fat” or “cooking oil”, depending on whether they are solid or liquid at room temperature.

The expression “bake-stable” according to the invention is used to indicate the fact that if subjected to dry heat, a fat-containing creamy composition only expands to a minimum (i. e. by maximally 25%), as can be determined by the following baking test method. For this purpose, a preparation is used which before the test, in the cooled state, has a creamy and paste-like consistency, such as a chocolate cream, a fruit preparation or a vegetable preparation. A metal ring of 1 cm height and 60 mm in diameter is placed on a piece of filter paper (Hahnenmühle company, Dassel Germany, type 589/1, DP 5891 090, ø 90 mm) and is filled with the preparation to be tested, which is placed on the filter paper and smoothed out on the surface of the metal ring. After evenly drawing off the metal ring, the filter paper, on which the preparation has been spread, is placed on a baking tray and baked in the preheated oven (top and bottom heat) for 10 minutes at 200° C. The form stability (diameter before baking in relation to the diameter after baking) of the preparation is assessed. The diameter of the preparation after baking may at most be 125% of the diameter before baking.

A soluble pectin according to the application is defined as a plant polysaccharide which, as a polyuronide, substantially consists of α-1,4-glycosidically bonded D-galacturonic acid units. The galacturonic acid units are partially esterified with methanol. The degree of esterification describes the percentage degree of carboxylic groups in the galacturonic acid units of the pectin which are present in esterified form, e. g. as methyl esters.

A high methoxyl pectin according to the invention is a pectin with a degree of esterification of at least 50%. A low methoxyl pectin, in contrast, has a degree of esterification of less than 50%. The degree of esterification describes the percentage degree of carboxylic groups in the galacturonic acid units of the pectin which are present in esterified form, e. g. as methyl esters. The degree of esterification can be determined by the method according to JECFA (monograph 19-2016, Joint FAO/WHO Expert Committee on Food Additives).

An “instant product” in the sense of the present invention is defined to be a semi-finished food product generally consisting of powder, granulate or dried ingredients, which is stirred into a cold or hot liquid. Cooking during preparation is omitted.

The term “seafood” in the present application is intended to indicate all edible marine animals which are no vertebrates. Typical seafood are clams and aquatic snails, squids and octopi, shrimps, crabs, crayfish and lobster. Seafood can be caught or be a farmed product.

An “extruder product” (synonymous with extrusion product) according to the invention is a product produced by extrusion, which is in general crispy and/or expanded and which can assume any desired shape depending on the nozzles used in the extrusion process. Examples of extruder products are: snacks such as peanut flakes, breakfast cereals, flatbreads, pasta products, sweets such as marshmallows and various extruded soy products which are used in numerous industrially produced foods, both as individual products and as components.

A “smoothie” is a cold mixed drink consisting of fruit and optional milk products, which is freshly prepared or sold as a finished product. Other than in fruit juices, the entire fruit and partly also the peel are used in smoothies. The basis of smoothies is therefore the fruit pulp or fruit puree which, depending on the recipe, is mixed with juices, water, milk, milk products or coconut milk so as to obtain a creamy and smooth consistency.

Within the context of the invention, a “nutritional supplement” is defined to be a food whose purpose it is to supplement the general diet; which is a concentrate of nutrients or other substances with a dietary or physiological effect, by itself or in combination; and which is marketed in dosed form, especially as capsules, lozenges, tablets, pills, effervescent or other similar forms of administration, powder bags, drop-dispensing bottles, bottles with dropper insert and other similar administration forms of liquids and powders for dosage in small metered amounts.

A “functional food” within the context of the invention is characterized by not only having a nutritional value and providing flavor experience, but in addition serving the purpose of long-term promotion and maintenance of health as a “functional” component. Thus, functional foods are predominantly used for preventive healthcare, improving health status and well-being. Important targets of functional foods are the gastrointestinal tract, the cardiovascular system, skin and the brain. Functional foods are consumed in a normal manner and not formulated as tablets, capsules or powders, other than nutritional supplements. The biologically active ingredients of functional foods are called nutraceuticals, which term is to designate their health-promoting effects. Frequently, probiotics and prebiotics, phytochemicals, omega-3 fatty acids, vitamins and dietary fibers are added to functional foods as nutraceuticals.

In the context of the invention and in accordance with the Deutsche Diätverordnung (German dietary regulation), a “dietary food” is defined to be a food destined for a specific group of people and for specific nutritional purpose; in addition, it significantly differs from food for general consumption. They are not used for the general diet of average consumers but for a well-defined group of people, such as people with disorders of digestion, resorption and metabolism, people in “particular physiological conditions” or healthy babies and infants.

The following groups of foods are examples of dietary foods: infant formulae and follow-on formulae; other foods for babies and infants (supplementary diet); low-calorie foods for weight loss; foods for special medical purposes (balanced diets); low-sodium foods including dietary salts which have a low sodium content or are entirely free of sodium; gluten-free foods (without additives); foods for intense muscle training, above all, for athletes; food for people suffering from disorders of the glucose metabolism (diabetics), enteral feeding and liquid food.

“Enteral food” according to the invention is a food which is liquid and of a viscosity low enough so that it can be administered via a feeding tube. It is a completely balanced diet for enteral feeding which is applied via a tube and an application system by the force of gravity or via a pump system. The standard foods cover all requirements of humans for carbohydrates, fats, protein, vitamins and trace elements, additionally containing dietary fibers. An isocaloric standard food has approximately 1.0 to 1.2 kcal/ml with a water content of 80% to 85%. If the energy density is higher, the diet involves high caloric standard food with a lower water content of 64% to 77%, which must be taken into account for liquid balancing.

“Liquid food” within the context of the present invention is a specially composed high-energy food in liquid form which can be drunk. It is used for additional or complete feeding if the patient cannot consume solid foods or can do it only to an insufficient degree.

“Feedstuff” (also briefly called feed) according to the invention is a collective term for all types of animal feed. The term comprises the food for all animals kept by humans, such as livestock, zoo animals, animals for sports or pets. Feedstuff today is specifically formulated for the respective species and purpose. Some examples are: feedstuff rich in starches which is produced from grains, seeds and tubers rich in starches; oleaginous feedstuff, feedstuff rich in protein, that is, containing 35-65% of protein, and other feedstuff obtained either from nature (e. g. fishmeal) or as an after-product from industrial production. These are, for instance, bran (from the mill), stillage (production of alcohol), brewer grains (production of beer), pomace (production of wine and juice), molasses and beet pulp from the sugar industry, and other food residues.

“Animal bedding” according to the invention designates materials which are used in animal husbandry for covering the ground in stables and cages and absorb the animals’ excrements.

A “wound dressing” is a dressing placed on external wounds in order to prevent the entry of foreign bodies into the wound and absorb blood and wound exudate. In addition, wound dressings may guarantee a warm and humid wound climate promoting healing, alleviate pain by means of contained substances, promote wound healing or have antimicrobial effects.

A “commodity good” in the sense of the present application is an article which, in accordance with § 2 subparagraph 6 of the German Lebensmittel-, Bedarfsgegenstände- und Futtermittelgesetzbuch (LFGB; Code on food, commodity goods and feedstuff), is selected from the list consisting of:
no. 1 materials and objects designed to come in contact with food (also called food commodity goods),
no. 2 packaging, containers or other casings designed to come in contact with cosmetics,
no.3 objects designed to come in contact with the mucosae of the mouth,
no. 4 objects designed for hygiene,
no. 5 toys and joke articles,
no. 6 objects designed to come not only temporarily in contact with the human body, such as clothing, bed cloth, masks, wigs, hairpieces, artificial eyelashes, wristbands,
no. 7 cleaning and care articles designed for domestic use or for commodity goods in the sense of number 1,
no. 8 impregnation agents and other equipment for commodity goods in the sense of number 6 which are designed for domestic use,
no. 9 means and objects for the improvement of smell in rooms designed for the accommodation of people.

A “filtering aid” according to the invention is a chemically inert substance which physically-mechanically supports filtration. It is not supposed to be confused with or equated to a flocculant. Filtering aids are employed to facilitate cleaning of the actual filter or filter insert or to prevent solid substances in the suspension from clogging the filter or getting into the filtrate. Filtering aids are generally used in water treatment, filtration of drinks and more specifically in the chemical industry.

An “egg substitute” according to the invention is a plant-based food which optically or in terms of taste as well as in its properties in the preparation of dishes resembles the whole egg, the egg white or the yolk. Use of a plant-based egg substitute can be associated with easier handling, a lower price and a lesser risk of food poisoning.

A “glazing agent” according to the invention is a food additive which protects the food from losses in smell, taste and moisture, promotes gloss or prolongs freshness. It can also function as a separating agent.

A “humectant” according to the invention is a food additive which prevents the drying out of foods by binding water added during production (i. e. preventing evaporation) or by attracting humidity of the air during storage. By preventing hardening of the finished food, it acts as a softening agent. In sweets, it counteracts crystallization of the sugar.

A “dietary fiber” according to the invention is a largely indigestible food component, generally consisting of carbohydrates, which predominantly exist in plant-based foods. For purposes of simplicity, dietary fibers are classified into water-soluble fibers (like pectin) and water-insoluble fibers (such as cellulose). Dietary fibers are considered an important part of the human diet. The EU Regulation on nutrition labelling globally assigns them a calorific value of 8 kJ/g.

A “reinforcing agent” according to the present invention is a single substance of a composite material. As the name suggests, the reinforcing agent is to guarantee rigidity and stiffness of the composite. What is most significant, in addition to its type, is the form of the reinforcing agent, namely whether it is present as a particle, a fiber or in layers. In particular, by “reinforcing agents” (“reinforcement”) the organic additives employed in plastics are understood which reinforce the plastics matrix. By “reinforcement”, the enhancement of mechanical and physical properties, such as elasticity, bending strength, creep mechanisms and heat deflection temperature are understood. Reinforcing agents are employed in a targeted manner to improve these material properties.

“Gelling agents” according to the invention are food additives which swell in water or bind water, i. e. lead to gelling. They form a gelatinous mass and give a viscid or solid consistency to soups, sauces or pudding.

A “solidifier” according to the invention is a food additive which ensures that solidity and freshness of a food remain during and after processing. It reacts with various components, such as e. g. pectin. A solidifier can be, for instance, a calcium salt which reacts with an ingredient of the product, such as the pectin in fruit.

A “texturant” according to the present application is a substance with the ability to provide a special texture to a product. By “texture”, in this context, the surface properties of food are understood which can be perceived by the tactile sense, in particular the mouthfeel of a product.

A “thickener” according to the present application is a substance which is, above all, capable of binding water. By removing unbonded water, viscosity is increased. Above a certain concentration, which is characteristic for each individual thickener, network effects are additionally produced which lead to a generally disproportionate increase in viscosity. Thickeners are capable of providing a product with a specific consistency. Thickening in this context means an increased viscosity or solidity of the product as a result of employment of the thickener.

A “filler” according to the invention is an insoluble additive which, added in large amounts to the basic material (of the matrix), strongly alters, among others, the mechanical, electric and processing properties of materials and can at the same time significantly decrease the portion of the matrix, which is typically more expensive, in the finished product. Preferably, a filler is a food additive which forms part of the food volume without substantially contributing to its content of usable energy. In this manner, the actual energy content per volume or per mass of the foods is reduced.

A “carrier” according to the invention is a substance to which other substances can be attached (physically bonded), i. e. which can “carry” other substances. For instance, a pharmaceutical agent or an aroma ingredient, which is otherwise difficult to dose, can be bonded to a carrier which is easier to dose. Preferably, the carrier is a technical adjuvant in the food industry and can transport flavors into the products, with the appearance and taste of a food generally not being modified by the carrier itself. As technical adjuvants, they do not have to be listed in the list of ingredients since they in themselves do not cause effects in the final product.

Within the context of the present invention, an “emulsifier” is an adjuvant which is used to combine two fluids which by themselves do not mix, such as oil and water, to form a finely distributed mixture, called an emulsion, and to stabilize it. The same applies to the mixing of solid, non-soluble substances with a liquid in order to stabilize a suspension. Preferably, the emulsifier is a food additive.

A “separating agent” according to the invention is a food additive or technical adjuvant which prevents sticking together or agglomeration of foods. Thus, separating agents are also among the agents which increase or maintain flowability. Thus, separating agents prevent salt, for example, from turning lumpy and individual pieces of candy from sticking together and forming one single block of sugar. As technical adjuvants, they are employed in industrial processing and production of foods. Technical adjuvants are food additives which are added in order to facilitate technical processes, such as cutting and filtration. In the final product, however, the technical adjuvants may not be present at all or only in low residual amounts which are unavoidable.

A “free flow agent” according to the invention is a separating agent which is added to crystalline substances in order to prevent agglomeration of the individual crystals, mainly for the purpose of better machine processability. Its use is to prevent the lumping of, for instance, table salt before or during processing, which makes it more difficult to dose.

A “stabilizer” according to the invention is a food additive which has the property of maintaining, if it is added to a metastable system, the characteristics, manageability, flavor or other parameters of this system in a defined manner, and thus of stabilizing it. A stabilizer can serve one or more functions.

An “improving agent for baking stability” according to the invention is characterized in that a liquid, viscous or cream-like composition, to which the improving agent is added, only spreads or flows minimally after the agent has been added and dry heat is applied.

A “foaming agent” according to the invention is a food additive which ensures that a homogeneous dispersion of gas forms in liquid or solid foods. Thus, foaming agents ensure that gases distribute evenly in liquids or solids.

A “whipping agent” according to the invention is an food additive which, after it has been added to a mass, allows increasing the volume of the mass by whipping air into it. Whipping agents stabilize the mass and thus facilitate the handling thereof. Whipping agents are used in the food industry for instance to produce sponge cake, chocolate mousse and other desserts.

An emergency bandage, also colloquially called an adhesive plaster or patch, is a piece of wound dressing attached to an adhesive tape. It is used to cover small wounds.

A “transdermal patch” according to the invention is a dosage form for the systemic administration of drugs in the form of patches. It is attached to the skin and releases the agent in a controlled manner, which agent is then resorbed by the skin. The agent reaches the circulatory system without previously having been broken down in the gastrointestinal tract or the liver.

Within the framework of the application, a “stoma” is understood to be an artificial connection between a body cavity and the body surface. Typical examples of a stoma are colostomy, ileostomy and urostomy. For the receiving of excrements, such as stool and/or urine, stoma products (e. g. ileostomy bags) are employed. These are bags attached to an adhesive surface. The adhesive surface is attached to the abdomen around the stoma and adheres to the skin.

Within the framework of the application, “cleaning agents” are consumables which are used to clean various articles and objects. The cause or support the removal of impurities due to usage, or of residues and adhering substances from the manufacturing process of the object. Different fields of application require different cleaning agents. For laundry and textiles, detergents (heavy-duty detergents, color detergents, fabric softeners etc.) or bile soap are employed. For dishes (cookware, dinnerware and cutlery) washing-up liquid, dishwashing agents or rinsing aids are used. For surfaces in living spaces and offices: neutral cleaners, abrasive cleaners (scouring powder) or window cleaners. Other cleaning agents are, for instance, lime removers, drain cleaners, brake cleaners, alcohol cleaners, all-purpose cleaners, glass cleaners, sanitary cleaners, toilet cleaners, carpet cleaners, car care material, oven cleaners, bathroom cleaners and metal polish.

In the context of the present application, a “lubricant” is a substance used for lubrication which serves to reduce friction and wear as well as to provide cooling, vibration damping, sealing and protection against corrosion. Principally, all lubricants consist of a basic liquid (generally base oil) and of other ingredients called additives. Examples of lubricants are liquid lubricants (lubricating oils and cooling lubricants), lubricating greases and solid lubricants (such as graphite).

Within the framework of the invention, “coolants” are liquid or solid substances or mixtures of substances which are used for the dissipation of heat.

A “composite material” is a material consisting of two or more bonded substances which has material properties different from those of its individual components. For the properties of composite materials, substantial properties and the geometry of the components are important. Size effects play a particular role.

Within the context of the present invention, “paints” are liquid or pasty, rarely powdery substances of mixtures which, if applied on surfaces, are subjected to physical drying or chemically curing processes. According to DIN 55945, a paint is a “liquid or pasty coating agent which is mainly applied by brushing or rolling”.

An “adhesive” according to the invention is a non-metal substance which is capable of bonding materials by surface (adhesion) and its inner stability (cohesion). That is, it is a process material employed to bond different materials in the adhesive bonding method. Examples are dispersion adhesive, melt adhesive, plastisol, cyanoacrylate adhesive, methyl methacrylate adhesive, unsaturated polyester adhesive, epoxy adhesive, polyurethane adhesive, silicones, phenolic resin adhesive, polyimide adhesive, polysulfide adhesive, bismaleimide adhesive, adhesive based on silane-modified polymers, silicone adhesive.

“Drilling fluids” (also called drilling mud) in the context of the present application are liquids which are pumped through the borehole in mining. There are two basic types of drilling fluids; those based on water and those based on oil. Drilling fluids are basically used for stabilizing a borehole, cleaning the borehole bottom and removing the bottom material (cuttings) which have been drilled out. In addition, they dissipate the frictional heat which has been induced on the trepan, thus cooling and lubricating the drilling tool. In addition, they reduce the frictional resistance of the trepan and the rotating boring rods and dampen their oscillations.

Fracking is a method of creating, widening and stabilizing cracks in the rocks of a deep deposit with the aim of increasing the permeability of the deposit rocks. In this manner, gases or liquids contained therein can flow more easily and continuously to the bore and be extracted there. In fracking, a fluid (“fracfluid”) is pressed into the geological horizon, from which extraction is supposed to take place, at a high pressure of typically several hundred bar. The fracfluid is water to which in general proppants, such as quartz sand, and thickeners have been added.

At this point, it is explicitly pointed out that features of the solutions described above, in the Claims and/or in the Figures can also be combined, if desired, in order to achieve cumulated implementation of the explained features, effects and advantages.

All features disclosed in the application documents are claimed as essential for the invention provided that they are, individually or in combination, novel over the state of the art.

It is explicitly pointed out that within the framework of the present patent application, indefinite articles and numerals such as “one”, “two” etc. are normally to be understood as indicating a minimum, i. e. “at least one...”, “at least two...” etc., unless it becomes explicitly clear from the context or is obvious or imperative to the person skilled in the art from a technical point of view that only “exactly one...”, “exactly two...” etc. can be intended.

Other advantages, particularities and expedient embodiments of the invention will become clear from the dependent Claims and the following presentation of preferred embodiments by means of the Figures.

The embodiments shown here are only examples of the present invention and are therefore not to be understood as limiting. Alternative embodiments considered by the person skilled in the art are equally comprised by the scope of protection of the invention.

### EXAMPLES OF EMBODIMENT

### 1 Description of the Manufacturing Process on the Basis of a Flow Chart

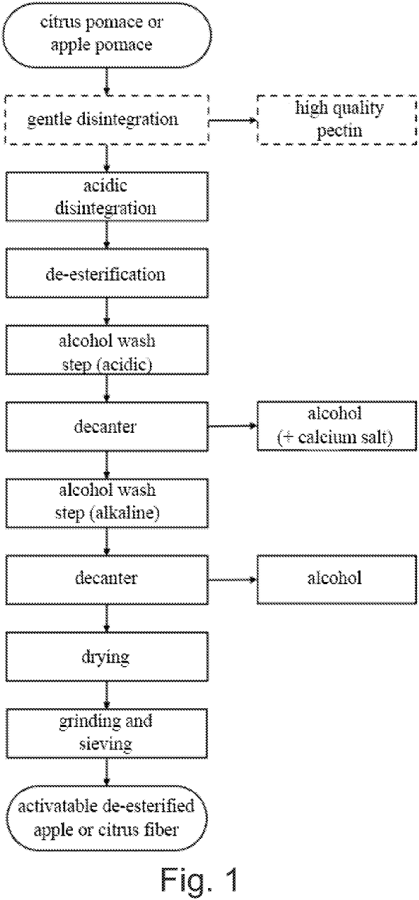

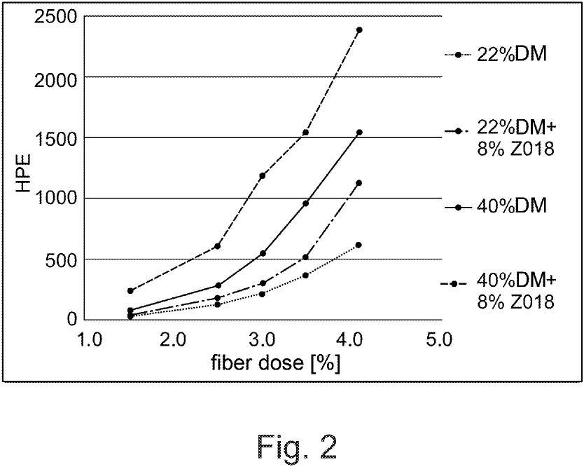

FIG. 1 shows a schematic flow diagram of a process for the production of an activatable pectin-converted citrus or apple fiber according to the invention. Starting from the citrus pomace or apple pomace, the pomace is gently disintegrated by acidic disintegration at a pH of between 2.5 and 5.0, thereby dissolving part of the protopectin present, which is subsequently separated from the fiber material as high-quality pectin by solid-liquid separation (e.g. with a decanter or a separator). Since this digestion step is optional, it has been marked with a dashed frame in the diagram. In the subsequent disintegration step, the fiber material obtained after acidic pre-incubation and separation of the pectin is disintegrated (“acidic disintegration”) by incubation in an acidic solution at a pH between 0.5 and 2.5 and a temperature between 70° and 80° C., and further pectin is extracted. Subsequently, the acidic disintegrated fiber material is de-esterified by treatment with a pectin methylesterase (“deesterification”). Then two washing steps are carried out with an alcohol-containing washing liquid, each followed by solid-liquid separation by means of a decanter. Here, the alcohol-containing washing liquid has an acidic pH in the first washing step and a basic pH in the second washing step. Since the pH adjustment in these two washing steps is optional, it has been shown in italics. Finally, the next step involves gentle drying of the fibers by means of fluidized bed drying, followed by a grinding and sieving step, to then obtain the citrus or apple fibers that can be used according to the invention.

### 2 Test Method for Determining the Yield Point (Rotational Measurement)

### Measurement Principle

This yield point is an indicator of the structural strength and is determined by rotational measurement, by increasing the shear stress acting on the sample over time until the sample begins to flow.

Shear stresses below the yield point merely cause an elastic deformation; it is only shear stresses above the yield point that will cause the sample to flow. This value is determined by measuring when a defined minimum shear rate γ is exceeded. According to the present method, the yield point τₒ [Pa] is exceeded at shear rate γ ≥ 0.1 s⁻¹.

| | |
|---|---|
| measuring device: | Rheometer Physica MCR series (e.g. MCR 301, MCR 101) |
| measuring system: | Z3 DIN or CC25, respectively |
| measuring vessel: | CC 27 P06 (ribbed measuring vessel) |
| number of stages: | 3 |
| measuring temperature: | 20° C. |
| measuring parameters: | |

1^{st} stage (resting period)

| | | |
|---|---|---|
| stage settings: | - default parameter: | shearing stress [Pa] |
| | - value: | 0 Pa constant |
| | - stage duration: | 180 s |
| | - temperature: | 20° C. |

2^{nd} stage (determining of yield point)

| | | |
|---|---|---|
| stage settings: | - default parameter: | shearing stress [Pa] |
| | - profile: | ramp log. |
| | - initial value: | 0.1 Pa |
| | - final value: | 80 Pa |
| | - stage duration: | 180 s |
| | - temperature: | 20° C. |

### Evaluation

The yield point τₒ (unit [Pa]) is read out in stage 2 and is the shearing stress (unit: [Pa]) at which the shear rate is for the last time γ ≤ 0.10 s⁻¹.

The yield point measured with the rotation method is also called “yield point (rotation)”.

The yield point (rotation) was measured using a fiber suspension (the fiber was simply stirred in with a spoon = corresponding to a non-activated fiber) and is also called “yield point (rotation) II” within the context of the invention. The yield point is also measured using a fiber dispersion (stirred in under the effect of high shearing forces, e. g. with Ultra Turrax = corresponding to an activated fiber) and is also called “yield point (rotation) I” within the context of the invention.

### 3 Test Method for Determining the Yield Point (Oscillation Measurement)

### Measurement Principle

This yield point is also an indicator of the structural strength and is determined in an oscillation test by increasing the amplitude at constant frequency until the sample is destroyed due to the ever-increasing excursion and starts to flow.

Below the yield point, the substance behaves like an elastic solid, i. e. the elastic portions (G′) amount to a larger portion than the viscous portions (G″) whereas when the yield point is exceeded, the viscous portions of the sample increase and the elastic portions decrease.

By definition, the yield point is exceeded at the amplitude when the amount of viscous portions equals that of elastic portions; G′ = G″ (cross over); the corresponding shear stress is the respective measured value.

| | |
|---|---|
| Measuring device: | Rheometer Physica MCR series |
| | (e.g. MCR 301, MCR 101) |
| Measuring system: | Z3 DIN or CC25 |
| Measuring vessel: | CC 27 P06 (ribbed measuring vessel) |

Measuring parameters

| | | |
|---|---|---|
| stage settings: | - amplitude defaults: | deformation [%] |
| | - profile: | ramp log. |
| | - value: | 0.01-1000% |
| | - frequency: | 1.0 Hz |
| | - temperature: | 20° C. |

### Evaluation

By means of the rheometer software Rheoplus, the shear stress at cross over is evaluated after the linear viscoelastic range has been exceeded.

The yield point measured with the oscillation method is also called “yield point (cross over)”.

The yield point (cross over) was measured using a fiber suspension (the fiber was simply stirred in with a spoon = corresponding to a non-activated fiber) and is also termed “yield point (cross over) II” within the framework of the invention. The yield point was additionally measured using a fiber dispersion (stirred in under the effect of high shearing forces, e. g. with Ultra Turrax = corresponding to a shear-activated fiber) and is also called “yield point (cross over) I” in the context of the invention.

### Measuring Results and Their Implications

If the yield point of the suspensions of the fibers used according to the invention, stirred in with a spoon (corresponding to a non-activated fiber), is compared to that of a fiber dispersion stirred in under high shearing forces, such as Ultra Turrax corresponding to an activated fiber), a statement on the advantage/necessity of an activation can be made. The measuring results are summarized in the table below. As can be expected, the yield point increases by shear activation in the dispersion. Due to the relatively low yield points of fiber suspensions τₒ II, full implementation of fiber properties requires activation of the fiber to obtain the desired creamy texture.

| fiber | rotation | | cross over | | activation |
|---|---|---|---|---|---|
| | τₒ II [Pa] suspension | τₒ I [Pa] dispersion | τₒ II [Pa] suspension | τₒ I [Pa] dispersion | |
| Activatable, de-esterified, pectin-converted citrus fiber used according to the invention | 0.7 | 4.8 | 0.4 | 5.5 | necessary |
| Activatable, de-esterified, pectin-converted apple fiber used according to the invention | 2.0 | 4.3 | 2.8 | 5.2 | necessary |

### 4 Test Method for Determining the Dynamic Weissenberg Number

### Measuring Principle and Meaning of the Dynamic Weissenberg Number:

The dynamic Weissenberg number W′ (Windhab E, Maier T, Lebensmitteltechnik 1990, 44: 185f) is a derived variable in which the elastic portions (G′) determined in the linear viscoelastic range are related to the viscous portions (G″) in an oscillation test:

$${W}^{′} = \frac{{G}^{′} \left(ω\right)}{{G}^{″} \left(ω\right)} = \frac{1}{t a n δ}$$

The dynamic Weissenberg number is a variable which correlates particularly well with the sensorial perception of consistency and can be regarded quite independently from the absolute firmness of the sample.

A high value of W′ means that the fibers have a predominantly elastic structure, whereas a low value of W′ indicates structures with clearly viscous portions. The creamy texture typical of fibers is achieved if the W′ values lie within a range of approximately 6 - 8; if the values are lower, the sample is assessed to be aqueous (thickened less strongly).

Material and methods

| | |
|---|---|
| measuring device: | Rheometer Physica MCR series, e.g. MCR 301, MCR 101 |
| measuring system: | Z3 DIN or CC25 |
| measuring vessel: | CC 27 P06 (ribbed measuring vessel) |

Measuring parameters

| | | |
|---|---|---|
| stage settings: | - amplitude defaults: | deformation |
| | - profile: | ramp log |
| | - value: | 0.01-1000% |
| | - frequency: | 1.0 Hz |
| - temperature: | 20° C. | |

### Evaluation

The angle of phase difference δ is read out within the linear viscoelastic range. Subsequently, the dynamic Weissenberg number W′ is calculated with the following formula:

$${W}^{′} = \frac{1}{t a n δ}$$

### Measuring Results and Their Implications:

Comparing the dynamic Weissenberg number W′ for the suspension of a fiber used according to the invention, stirred in with a spoon (corresponding to a non-activated fiber) with a fiber dispersion, stirred in with high shearing forces, e. g. Ultra Turrax (corresponding to an activated fiber), a statement on the texture and, in addition, on the necessity of an activation can be made. The measuring results are summarized in the table below. The activatable, de-esterified, pectin-converted citrus and apple fiber used according to the invention are, with W′ values of 8.6 and 6.3, respectively, in the suspension and 8.8 and 7.0, respectively, for the dispersion, in the ideal range and thus have an optimum texture. The texture is in both cases creamy. Thus, the results concerning the dynamic Weissenberg number show that activation of the fiber is not absolutely necessary to obtain a desired creamy texture.

| fiber | W′ suspension | W′ dispersion | texture |
|---|---|---|---|
| Activatable, de-esterified, pectin-converted citrus fiber used according to the invention | 8.6 | 8.8 | creamy with and without activation, viscosity/yield point are regulated by dosing |

### 5 Testing Method for Determining Firmness

### Method

150 ml distilled water are introduced into a beaker. Then 6.0 g of de-esterified citrus fibers or de-esterified apple fibers are stirred into the water with a spoon without formation of lumps. For swelling, this fiber-water mixture is left to stand for 20 min. The suspension is then transferred into a vessel (Ø 90 mm). Subsequently, the firmness is measured with the following method:

| | |
|---|---|
| Measuring device: | Texture Analyser TA-XT 2 (company Stable Micro Systems, Godalming, UK) |
| Testing method/option: measuring of force in the direction of pressure / simple test | |
| Parameters: | - testing speed: 1.0 mm/s |
| | - distance: 15.0 mm/s |
| Measuring tool: | - P/50 |

The firmness corresponds to the force required by the measuring bob to penetrate into the suspension by 10 mm. This force is then read out from the force-time diagram. It is to note that due to the history of the firmness measurement the unit of measured firmness has manifested itself in grams (g).

### 6 Test Method for Determining Breaking Strength or Breaking Strength Test

### Recipe for 22°Brix

5.7, 9.5, 11.4, 13.3, 15.6 g fiber (corresponds to 1.5, 2.5, 3.0, 3.5 and 4.1 wt% in the final product)

| 320.0 g | 0.65 mol/L potassium acetate-lactic acid-buffer solution |
|---|---|
| 60 g | sugar (saccharose) at |
| 2 - 3 drops | defoamer |
| Initial weight: | approx. 390 g |
| Final weight: | 380 g |
| pH value: | 3.0 ± 0.1 |
| dry matter content: | 40.0 ± 1.0 % |

### Recipe for 40°Brix

5.7, 9.5, 11.4, 13.3, 15.6 g fiber (corresponds to 1.5, 2.5, 3.0, 3.5 and 4.1 wt% in the final product)

| 320.0 g | 0.65 mol/L potassium acetate-lactic acid-buffer solution |
|---|---|
| 135 g | sugar (saccharose) at |
| 2 - 3 drops | defoamer |
| Initial weight: | approx. 465 g |
| Final weight: | 380 g |
| pH value: | 3.0 ± 0.1 |
| dry matter content: | 40.0 ± 1.0 % |

### Measurement Method

The boiling is carried out on an induction hob at medium heat.
Place the buffer solution in a stainless steel pot.
Mix fiber with part of the total sugar (approx. 30 g) homogeneously in mixing bottle or glass dish.
Sprinkle the fiber-sugar mixture into the cold buffer solution while stirring and bring the mixture to a boil over medium heat. Continue to boil over medium heat while stirring.
Clean the mixing bottle or glass dish twice with approx. 10 - 15 g sugar each (from total sugar amount) and add the sugar to the mixture while stirring.
Add remaining sugar quantity one after the other in 3 portions (approx. 50 g each) and heat up to boiling point while stirring after each addition. Then boil at medium heat to final weight.
Upon reaching the final weight, immediately weigh 100 ± 1 g each of the boil rapidly into three Lüers beakers with a tear figure inserted.
Place the beakers in a water bath (20 ± 1° C.) placed immediately next to the boiling point, avoiding vibration, and temper. The Lüers beakers must be in the water up to the filling level of the gel. The water level must be regulated when numerous specimens are placed in or removed from the water bath.
After exactly 2 hours, the breaking strength is measured with the Herbstreith Pektinometer Mark III or successor models. The result is the mean value of the three individual values.

### Evaluation

As the following two tables show, with increasing fiber dosage, the breaking strength increases strongly both at a soluble dry matter content of 22% DM and at 40% DM. The breaking strengths also increase with the addition of a complexing agent/soluble ion exchanger, as in this case with the addition of sodium polyphosphate with a chain length of approx. 30.

The background for this increase is presumably the binding of the calcium ions naturally present in the fiber, which pushes back the pre-gelation of the low methoxyl pectin contained in the fiber.

TABLE 1

Breaking strength at 22°Brix (Na-PP = sodium polyphosphate)

| fiber | Na-PP [%] Relative to fiber | Fiber dose [%] | Ø HPE | Ø K-value | pH-value | DM [%] |
|---|---|---|---|---|---|---|
| Activatable, de-esterified, pectin-converted citrus fiber | - | 1.5 | 27 | 9.3 | 3.05 | 20.4 |
| | 8.0 | | 43 | 5.3 | 3.07 | 20.2 |
| | - | 2.5 | 132 | 7.3 | 3.12 | 20.0 |
| | 8.0 | | 178 | 5.1 | 3.10 | 20.4 |
| | - | 3.0 | 215 | 8.6 | 3.10 | 20.2 |
| used according to the invention | - | | 312 | 18.3 | 3.12 | 21.4 |
| | 8.0 | | 305 | 6.3 | 3.11 | 20.4 |
| | - | 3.5 | 369 | 8.2 | 3.12 | 20.4 |
| | 8.0 | | 516 | 5.6 | 3.11 | 20.4 |
| | - | 4.1 | 673 | 6.4 | 3.14 | 18.0 |
| | 8.0 | | 1130 | 22.9 | 3.22 | 18.4 |

TABLE 2

Breaking strength at 40°Brix (Na-PP = sodium polyphosphate)

| fiber | Na-PP [%] Relative to fiber | Fiber dose [%] | Ø HPE | Ø K-value | pH-value | DM [%] |
|---|---|---|---|---|---|---|
| Activatable, de-esterified, pectin-converted citrus fiber used according to the invention | - | 1.5 | 78 | 6.6 | 3.08 | 39.8 |
| | 8.0 | | 240 | 6.1 | 3.05 | 39.8 |
| | - | 2.5 | 282 | 7.2 | 3.08 | 40.2 |
| | 8.0 | | 611 | 5.1 | 3.06 | 40.4 |
| | - | 3.0 | 543 | 9.2 | 3.09 | 40.1 |
| | 8.0 | | 1187 | 7.0 | 3.10 | 40.8 |
| | - | 3.5 | 964 | 10.5 | 3.11 | 40.2 |
| | 8.0 | | 1545 | 6.9 | 3.10 | 40.0 |
| | - | 4.1 | 1540 | 10.0 | 3.11 | 40.2 |
| | 8.0 | | 2393 | 8.4 | 3.12 | 40.9 |

### Determination of the Thermo-Reversibility of Gel Formation Based on Breaking Strength

The test gels, which were prepared according to the above formulation at 40°Brix and 3.0 wt% fiber concentration, were tested for breaking strength as previously described after initial filling. Then the gels were heated to boiling under stirring and melted and resolidified by storing at room temperature. This was done a total of three times and the breaking strength was measured in each cooled state. This showed that the fibers could be melted for a total of three times after the first cooling, and could form a gel again after cooling without significantly losing strength.

Within the range of variation of the measurement results, it did not matter whether the fibers were added dry or as a dispersion (via Ultra Turrax, see Method 8) to the gel formulation.

The breaking strength could also be significantly increased in these thermo-reversibility tests by the addition of sodium polyphosphate, and this increased strength was also maintained after melting and cooling three times.

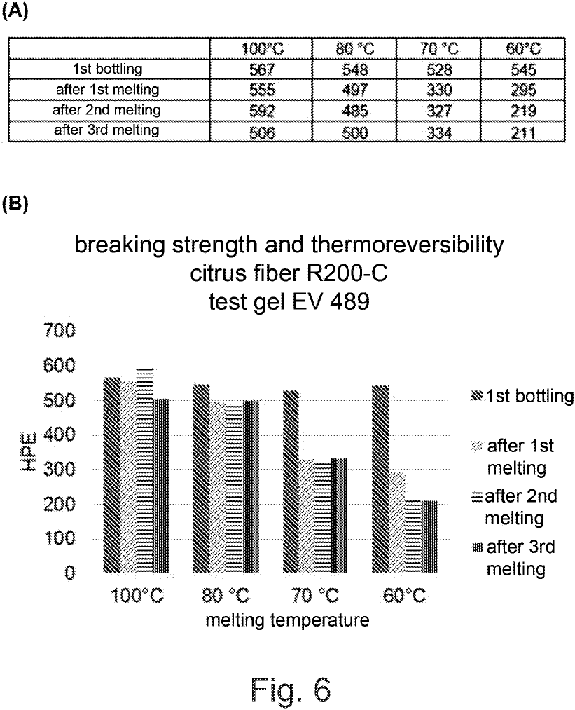

In another experiment, the thermo-reversibility was measured by the breaking strength at different melting temperatures. The results are shown in FIG. 6. Here it can be seen that the breaking strength increases with the melting temperature.

### 7 Test Method for Determining the Particle Size

### Measurement Principle

In a sieving machine, a set of sieves with a mesh width continuously increasing from the lower sieve to the upper sieve is arranged on top of each other. The sample is placed on the top sieve - the one with the largest mesh width. The sample particles with a diameter larger than the mesh width remain on the sieve; the finer particles fall onto the sieve below it. The portion of sample on the various sieves is weighed and indicated as a percentage.

### Method

The sample is weighed in to the second decimal digit. The sieves are provided with sieving aids and stacked on top of each other with the mesh width increasing. The sample is quantitatively transferred onto the top sieve; the sieves are clamped in, and the sieving process is performed according to defined parameters. The individual sieves are weighed with the sample and the sieving aid as well as empty with the sieving aid. If for a product, only a limit value within the particle size spectrum is to be tested (e. g. 90% < 250 µm), only a sieve with the respective mesh width is used.

Measuring defaults

| | |
|---|---|
| sample amount: | 15 g |
| sieving aids: | 2 per sieve bottom |
| sieving machine: | AS 200 digit, Retsch GmbH company |
| sieving movement: | three-dimensional |
| oscillation height: | 1.5 mm |
| sieving duration: | 15 min |

The sieve structure consists of the following mesh widths in µm: 1400, 1180, 1000, 710, 500, 355, 250, 150, followed by the bottom.

The particle size is calculated using the following formula:

$$\text{portion per sieve in \%} \text{=} \frac{\text{final weight in g on the sieve x 100}}{\text{initial sample weight in g}}$$

### 8 Preparation of a 2.5 Wt% Fiber Dispersion

### Formula:

2.5 g fiber
97.5 g demineralized water (room temperature)
duration of sprinkling: 15 seconds

The respective amount of demineralized water (room temperature) is introduced into a 250 ml beaker. The exactly weighed amount of fiber is slowly and directly poured into the stirring maelstrom with the stirring unit (Ultra Turrax) running at 8000 rpm (level 1). The sprinkling duration depends on the amount of fibers; it is to last 15 seconds per 2.5 g of sample. Then the dispersion is stirred for exactly 60 seconds at 8000 rpm (level 1). If the sample is to be used for determining viscosity or for determining the yield point I (rotation), the yield point I (cross over) or for determining the dynamic Weissenberg number, it is placed in a temperature-controlled water bath at 20° C.

For measuring viscosity or for measuring the yield point I (rotation), the yield point I (cross over) or for measuring the dynamic Weissenberg number, the sample is carefully given, after exactly 1 hour, into the measurement system of the rheometer, and the respective measurement is started. If the sample settles, it is carefully stirred up by means of a spoon directly before bottling.

### 9 Preparation of a 2.5 Wt% Fiber Suspension

### Formula

2.50 g fiber
97.5 g demineralized water (room temperature)

The respective amount of demineralized water (room temperature) is introduced into a 250 ml beaker. The exactly weighed amount of citrus fiber is slowly poured in with a plastic spoon under constant stirring. Then the suspension is stirred until all fibers are watered. If the sample is to be used for determining viscosity or for determining the yield point II (rotation), the yield point II (cross over) or for determining the dynamic Weissenberg number, it is placed in a temperature-controlled water bath at 20° C.

For measuring viscosity or for measuring the yield point II (rotation), the yield point II (cross over) or for measuring the dynamic Weissenberg number, the sample is carefully filled into the measurement system of the rheometer after exactly 1 hour, and the measurement is started. If the sample settles, it is carefully stirred up by means of a spoon directly before bottling.

### 10 Test Method for Determining Water Binding Capacity

### Implementation for Water Binding Capacity of Non-Pretreated Samples

The sample is left to swell over 24 hours with a water excess at room temperature. After centrifugation and subsequent decanting of the supernatant, the water binding capacity can be gravimetrically determined in g H₂O/g sample. The pH value in the suspension is to be measured and documented.

The following parameters are to be observed:

Weighed portions

| | |
|---|---|
| - plant fiber: | 1.0 g (in centrifuge tube) |
| - water addition: | 60 ml |
| - centrifugation: | 4000 g |
| - duration of centrifugation: | 10 min |

20 minutes after beginning of centrifugation (i. e. 10 minutes after the end of centrifugation), the water supernatant is separated from the welled sample. The sample with the bound water is weighed.

The water binding capacity (WBC) in g H₂O/g sample can now be calculated with the following formula:

$$W B C \left(\frac{g H 2 O}{g s a m p l e}\right) = \frac{s a m p l e w i t h b o u n d w a t e r \left[g\right] - 1.0 g}{1.0 g}$$

11 Testing method for determining viscosity

| measuring device: | Physica MCR series (e. g. MCR 301, MCR 101) |
|---|---|
| measuring system: | Z3 DIN or CC25 (note: the measuring systems Z3 DIN and CC25 are identical) |
| number of stages: | 4 |

Measuring parameters
1^{st} stage

| stage settings | - default parameter | shearing speed [s⁻¹] |
|---|---|---|
| | - profile: | constant |
| | - value: | 0 s⁻¹ |
| | - stage duration: | 60 s |
| | - temperature: | 20° C. |
| 2^{nd} stage | | |
| stage settings | - default parameter | shearing speed [s⁻¹] |
| | - profile: | ramp linear |
| | - valu120 | 0.1–100 s⁻¹ |
| | - stage duration: | 120 s |
| | - temperature: | 20° C. |
| 3^{rd} stage | | |
| stage settings: | - default parameter | shearing speed [s⁻¹] |
| | - profile: | constant |
| | - value: | 100 s⁻¹ |
| | - stage duration | 10 s |
| | - temperature | 20° C. |
| 4^{th} stage | | |
| stage settings: | - default parameter | shearing speed [s⁻¹] |
| | - profile | ramp linear |
| | - value | 100-0.1 s⁻¹ |
| | - stage duration | 120 s |
| | - temperature | 20° C. |

### Evaluation

The viscosity (unit [mPas]) is read out as follows: 4^{th} stage at = 50 s⁻¹

### Determination of Viscosity Dependent on Different Washing Liquids:

An activatable, de-esterified, pectin-converted citrus fiber was prepared using the process previously described and shown in FIG. 1, varying the two-step washing step with the washing liquid containing 50, 60 or 70 vol% isopropanol (IPA) as follows:
No acid/base addition (50, 60, 70% IPA).
Addition of nitric acid in 1st washing step (IPA/HNO3)
Addition of nitric acid/Na-PP in 1st washing step (IPA/HNO3/Na-PP)
Addition of hydrochloric acid in the 1st washing step (IPA/HCl)
Addition of citric acid in the 1st washing step (IPA/Citric acid)
Addition of ammonia solution in the 2nd washing step (IPA/NH3)
Addition of ammonia solution plus EDTA in the 2nd washing step (IPA/NH3/EDTA)

Subsequently, for the activatable de-esterified pectin-converted citrus fibers obtained from the manufacturing process, the viscosity was determined in a 2.5 wt% dispersion prepared according to Method 8 at 20° C. and D= 50 s⁻¹. Here, the dispersion was prepared without addition of sodium polyphosphate (Na-PP) or with addition of 2, 4, 8 or 10 wt% Na-PP.

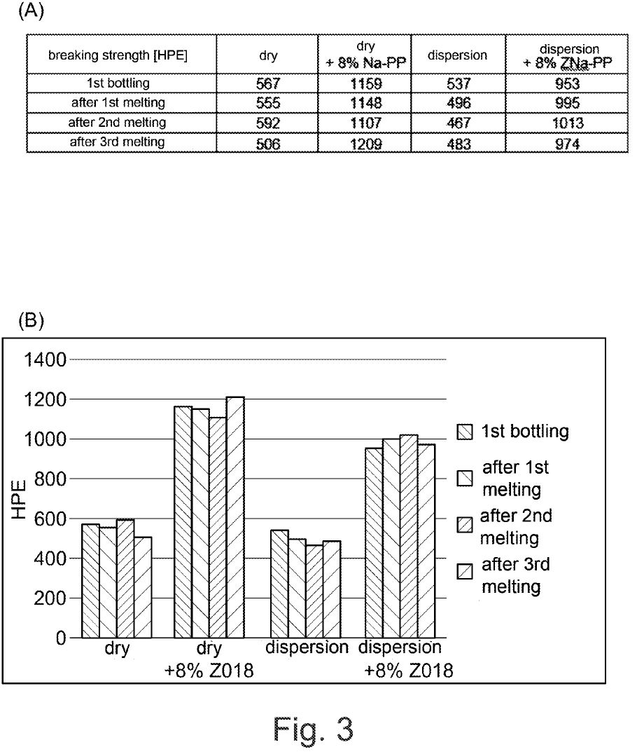

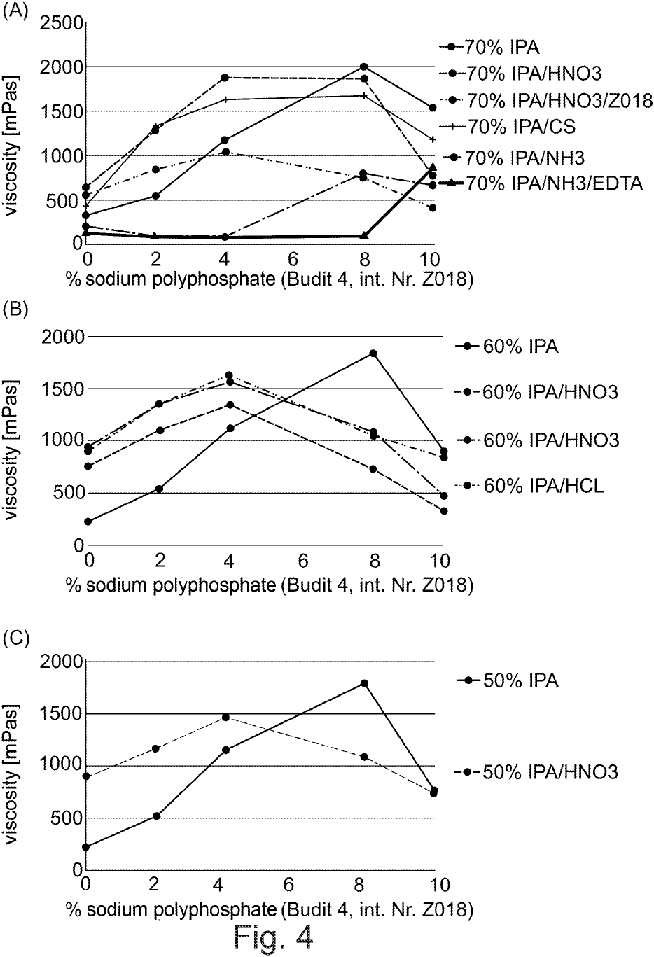

The results are shown graphically in FIG. 4, A to C.

These tests were carried out due to the increase in gel breaking strength by addition of the calcium chelator Na-PP, which suggested the presence of residual calcium ions and thus strength-inhibiting pre-gelation. Washing the fiber with acidic alcohol should remove the calcium present in the fiber and thus reduce the suspected pre-gelation. If this is the case, the viscosity without addition of sodium polyphosphate (corresponding to 0% Na-PP) should be higher than in the comparative sample (washing without acid addition) and the curve shape as a function of Na-PP concentration should be significantly flatter. The higher the water content selected for washing, the stronger the effect should be.

With all three selected IPA concentrations in the washing alcohol (50%, 60% and 70%), the expected behavior was achieved. The viscosity increase was comparable when using 60% IPA and 50% IPA with acid and significantly higher than with 70% IPA plus acid. The type of acid (HCl, HNO3, citric acid) had a minor effect on the viscosities obtained.

The addition of sodium polyphosphate when washing with 70% IPA/HNO3 probably resulted in lower viscosity due to the higher pH.

### 12 Testing Method for Determining the Degree of Esterification

This method corresponds to the method published by JECFA (Joint FAO/WHO Expert Committee on Food Additives). Other than in the JECFA method, however, the deashed pectin is not dissolved in the cold, but heated. Isopropanol instead of ethanol is used as the alcohol.

### 13 Determining the Gelling Strength

The gelling strength can be determined by means of the standard procedure for the grade evaluation of the pectin in a gel with 65 % dry substance. It corresponds to method 5-54 of the IFT Committee on Pectin Standardisation (Food Technology, 1959, 13: 496 - 500).

### 14 Testing Method for Determining the Dietary Fiber Content

This method substantially corresponds to the one published by the AOAC (Official Method 991.43: Total, Soluble and Insoluble Dietary Fiber in Foods; Enzymatic-Gravimetric Method, MES-TRIS Buffer, First Action 1991, Final Action 1994). The only difference is that isopropyl alcohol was used here instead of ethanol.

### 15 Testing Method for Determining Moisture

### Principle

The moisture content of the sample is understood to be the reduction in mass after drying, determined according to defined preconditions. The moisture content is determined by means of infrared drying with the moisture analyzer Sartorius MA-45 (Sartorius company, Göttingen, Federal Republic of Germany).

### Method

Approximately 2.5 g of the fiber sample are weighed in on the Sartorius moisture analyzer. The settings of the device can be found in the respective factory measuring instructions. For measuring, the samples are to have approximately room temperature. The moisture content is automatically indicated in percent [% M] by the device. The content of dry substance is automatically indicated in percent [% S] by the device.

### 16 Testing Method for Determining Color and Lightness

### Principle

The measurements of color and lightness are performed with the Minolta Chromameter CR 300 or CR 400, respectively. The spectral characteristics of a sample are determined using tristimulus values. The color of a sample is described using the hue, the lightness and saturation. With these three basic properties, the color can be represented three-dimensionally.

The hues are located on the external face of the color solid; the lightness changes on the vertical axis and the degree of saturation horizontally. If the L*a*b* measurement system is employed, L* represents lightness whereas a* and b* indicate both the hue and the saturation. a* and b* indicate the positions on two color axes, with a* being assigned to the red-green axis and b* being assigned to the blue-yellow axis. For indicating the color measurement values, the device converts the tristimulus values into L*a*b* coordinates.

### Performance of Measurement

The sample is sprinkled on a white sheet of paper and flattened with a glass plug. For measurement, the measuring head of the chromameter is directly placed on the sample and the trigger is actuated. A triple measurement is performed of each sample and the average value calculated. The L*, a* and b* values are indicated by the device with two decimals.

The embodiments shown here are only examples of the present invention and are therefore not to be understood as limiting. Alternative embodiments considered by the person skilled in the art are equally comprised by the scope of protection of the present invention.

### 17 Testing Method for Determining Water-soluble Pectin In Fiber-Containing Samples

### Principle

By aqueous extraction, the pectin contained in fiber-containing samples is converted into the liquid phase. By the addition of alcohol, the pectin is precipitated from the extract as an alcohol-insoluble substance (AIS).

### Extraction

10 g of the sample to be examined is weighed into a glass bowl. 390 g of boiling distilled water is introduced into a beaker, and the previously weighed sample is stirred into it for 1 minute at the maximum level with Ultra-Turrax.

The sample suspension cooled to ambient temperature is divided over four 150 ml-centrifuge beakers and centrifuged over 10 min at 4000 x g. The supernatant is collected. The sediment of each beaker is re-suspended with 50 g of distilled water and again centrifuged over 10 min at 4000 x g. The supernatant is collected, the sediment discarded.

The combined centrifugates are added to approximately 4 1 of isopropanol (98%) for precipitation of the alcohol-insoluble substance (AIS). After ½ hour, filtration takes place by a filter cloth and the AIS is manually pressed out. In the filter cloth, the AIS is then added to approximately 3 1 of isopropanol (98%) and manually, with use of gloves, loosened.

The pressing procedure is repeated, the AIS quantitatively removed from the filter cloth, loosened and dried at 60° C. in a drying oven for 1 hour.

0.1 g of the dried substance which has been pressed out is weighed for calculation of the alcohol-insoluble substance (AIS).

### Calculation:

Calculation of the water-soluble pectin, with reference to the fiber-containing sample, is performed according to the following formula, with the water-soluble pectin being precipitated as the alcohol-insoluble substance (AIS):

$$A I S i n t h e s a m p l e i n w t \% \left(\frac{g}{100 g}\right) = \frac{d r i e d A I S \left[g\right] x 100}{i n i t i a l s a m p l e w e i g h t i n g}$$

### 18 Tribological Characterization of a Fiber Dispersion as a Function of Concentration Using the Coefficient of Friction µ

### Measurement Performance

Physica MCR 302 rheometer, tribology measuring cell T-PTD200, 3 PDMS pins at the bottom, sodium glass sphere at the top.

### 1^{st} Stage

Conditioning F_{N} = 1 N t = 60 s

### 2^{nd} Stage

Sliding velocity ramp
F_{N} = 1 N
T = 25° C.
vₛ = 10⁻⁴ - 100 mm/s (log)
t = 250 s

### Results

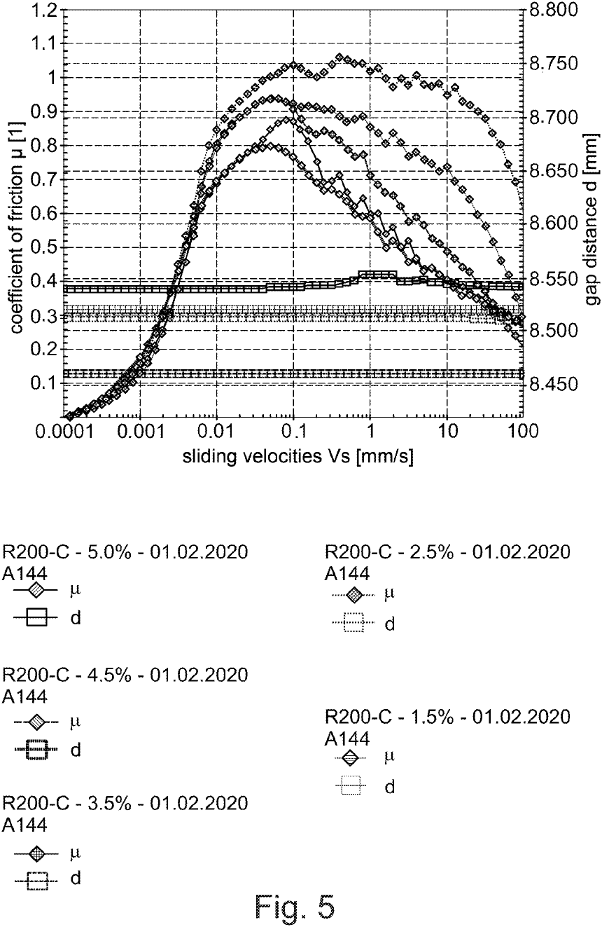

The results are shown graphically in FIG. 5. At sliding velocities of vₛ = 0.01 - 0.05 mm/s, i.e. in the range just below the breakaway torque (maximum of the Stribeck curve), the coefficient of friction µ of the 1.5% fiber dispersions (dark blue curve) is above the two dispersions with a dosage of 2.5% and 3.5% (green and yellow curve) and above the two dispersions with the lowest values with a dosage of 4.5% and 5.0% (light blue and pink curve).

This corresponds to a sensory perceived higher creaminess of the fiber dispersions with increasing concentration.

Above the breakaway torque at sliding speeds in the range from vₛ > 0.1 mm/s, the curves are in the order corresponding to the concentration used - the higher the fiber content, the lower the friction coefficients, i.e. the creamier the mouthfeel.

1. A method of preparing a product comprising providing an activatable, de-esterified, pectin-converted fruit fiber, wherein the product is selected from the group consisting of food products, feeding stuff, commodity goods, animal need, hygiene products, personal care products, cleaning agents, coating agents, care agents, explosives, lubricants, cooling agents, plastic products, fabrics, imitation leather, varnish, ink, paints, building materials, composite materials, paper, cardboard, adhesives, fertilizers, drugs, medical products, batteries, characterized in that the activatable, de-esterified, pectin-converted fruit fiber has a content of water-soluble pectin of 5 to 35 wt%.

2. A method of preparing a product comprising providing an activatable, de-esterified, pectin-converted fruit fiber, wherein the product is in the construction area, in extraction by drilling boreholes and in agriculture, characterized in that the activatable, de-esterified, pectin-converted fruit fiber has a content of water-soluble pectin of 5 to 35 wt%.

3. The method according to claim 1, characterized in that the activatable, de-esterified, pectin-converted fruit fiber has one or more of the following functions: as a foaming agent, a whipping agent, a release agent, a free flow agent, a stabilizer, an emulsifier, a carrier, a filler, a texturing agent, a thickener, a gelling agent, a solidifying agent, a dietary fiber, a reinforcing agent, a humectant, a filter aid, an egg substitute, a glazing agent, an improving agent for freeze-thaw stability and an improving agent for baking stability.

4. The method according to claim 1, characterized in that the activatable, de-esterified, pectin-converted fruit fiber has a content of water-soluble pectin of 5 to 35 wt% and the pectin is a low methoxyl pectin and wherein the fruit fiber is preferably an activatable, de-esterified, pectin-converted citrus fiber or an activatable, de-esterified, pectin-converted apple fiber.

5. The method according to claim 1, characterized in that the activatable, de-esterified, pectin-converted fruit fiber is an activatable, de-esterified, pectin-converted citrus fiber which has one or more of the following properties:
a. a yield point II (rotation) in the fiber suspension of more than 0.1 Pa, advantageously of more than 0.6 Pa, and particularly advantageously of more than 1.0 Pa;
b. a yield point II (cross over) in the fiber suspension of more than 0.1 Pa, advantageously of more than 0.4 Pa, and particularly advantageously of more than 0.6 Pa;
c. a yield point I (rotation) in the fiber dispersion of more than 1.0 Pa, advantageously of more than 3.5 Pa, and particularly advantageously of more than 5.5 Pa;
d. a yield point I (cross over) in the fiber dispersion of more than 1.0 Pa, advantageously of more than 4.0 Pa, and particularly advantageously of more than 6.0 Pa;
e. a dynamic Weissenberg number in the fiber suspension of greater than 5.5, advantageously of greater than 6.5, and particularly advantageously of greater than 8.0;
f. a dynamic Weissenberg number in the fiber dispersion of greater than 6.0, advantageously of greater than 7.0 and particularly advantageously of greater than 8.5;
g. a firmness in a 4 wt% aqueous suspension of greater than 100 g, preferably of greater than 125 g, and particularly preferably of greater than 150 g;
h. a viscosity of greater than 300 mPas, preferably of greater than 400 mPas, and particularly preferably of greater than 500 mPas, wherein the activatable, de-esterified, pectin-converted citrus fiber is dispersed in water as a 2.5 wt% solution and the viscosity is measured with a shear rate of 50 s-1 at 20° C.;
i. a water binding capacity of more than 22 g/g, preferably of more than 24 g/g, particularly preferably of more than 26 g/g;
j. a moisture of less than 15%, preferably less than 10% and particularly preferably less than 8%;
k. in a 1.0 wt% aqueous solution, a pH value of 3.0 to 7.0 and preferably of 4.0 to 6.0;
l. a particle size wherein at least 90% of the particles are smaller than 450 µm, preferably at least 90% of the particles are smaller than 350 µm and particularly preferably at least 90% of the particles are smaller than 250 µm;
m. a lightness value L* > 84, preferably L* > 86 and particularly preferably L* > 88;
n. a fiber content of the activatable, de-esterified, pectin-converted citrus fiber of 80 to 95%;
o. the activatable, de-esterified, pectin-converted citrus fiber comprises a content of water-soluble pectin of 10 to 35 wt% and particularly preferably of 15 to 30 wt%.

6. The method according to claim 1, characterized in that the activatable, de-esterified, pectin-converted fruit fiber is an activatable, de-esterified, pectin-converted apple fiber which has one or more of the following properties:
a. a yield point II (rotation) in the fiber suspension of more than 0.1 Pa, advantageously of more than 0.6 Pa, and particularly advantageously of more than 1.0 Pa;
b. a yield point II (cross over) in the fiber suspension of more than 0.1 Pa, advantageously of more than 0.4 Pa, and particularly advantageously of more than 0.6 Pa;
c. a yield point I (rotation) in the fiber dispersion of more than 1.0 Pa, advantageously of more than 3.5 Pa, and particularly advantageously of more than 5.5 Pa;
d. a yield point I (cross over) in the fiber dispersion of more than 1.0 Pa, advantageously of more than 4.0 Pa, and particularly advantageously of more than 6.0 Pa;
e. a dynamic Weissenberg number in the fiber suspension of greater than 5.5, advantageously of greater than 6.5, and particularly advantageously of greater than 8.0;
f. a dynamic Weissenberg number in the fiber dispersion of greater than 6.0, advantageously of greater than 7.0 and particularly advantageously of greater than 8.5;
g. a firmness in a 4 wt% aqueous suspension of greater than 100 g, preferably of greater than 125 g, and particularly preferably of greater than 150 g;
h. a viscosity of greater than 300 mPas, preferably of greater than 400 mPas, and particularly preferably of greater than 500 mPas, wherein the activatable, de-esterified, pectin-converted apple fiber is dispersed in water as a 2.5 wt% solution and the viscosity is measured with a shear rate of 50 s-1 at 20° C.;
i. a water binding capacity of more than 22 g/g, preferably of more than 24 g/g, particularly preferably of more than 26 g/g;
j. a moisture of less than 15%, preferably less than 10% and particularly preferably less than 8%;
k. in a 1.0 wt% aqueous solution, a pH value of 3.0 to 7.0 and preferably of 4.0 to 6.0;
l. a particle size wherein at least 90% of the particles are smaller than 450 µm, preferably at least 90% of the particles are smaller than 350 µm and particularly preferably at least 90% of the particles are smaller than 250 µm;
m. a lightness value L* > 60, preferably L* > 61 and particularly preferably L* > 62;
n. a fiber content of the activatable, de-esterified, pectin-converted apple fiber of 80 to 95%;
o. the activatable, de-esterified, pectin-converted apple fiber comprises a content of water-soluble pectin of 5 to 22 wt% and particularly preferably of 8 to 15 wt%.

7. The method according to claim 1, characterized in that the food product is selected from the group consisting of preserved products, deep-frozen foods, vegan food, vegetarian food, gluten-free food, low-calorie food, low-sugar food, lactose-free food, jelly, jelly-type sweets, sauce, granola bars, fruit pieces, fruit snacks, fruit bars, milk substitute drink, milk substitute product, foam sugar products, sherbet, ice cream, desserts, fermented drink, milk product, delicacies, fruit drink, fruit drink containing alcohol, cocktail, vegetable drink, chutney, barbecue sauce, smoothies, instant drink, fruit spread, fruit compote, fruit dessert, fruit sauce, fruit preparations, bake-stable fruit preparations, fruit preparations for yoghurt, bake-stable vegetable preparations, bake-stable fatty fillings, baked goods, pasta and pasta fillings, noodle dishes, potato snack, cheese and cream cheese preparations, meat substitute products, extruder products, corn flakes, breakfast cereals, soup, sauce, mayonnaise, meats, sausages, sausage casing, seafood, spirits, lozenges, functional food, nutritional supplements and dietary foods such as enteral foods, dysphagia food or sip feed.

8. The method according to claim 1, characterized in that the feeding stuff is selected from the group consisting of feeding stuff rich in starches, oleaginous feedstuff, feedstuff rich in protein, extrudate feedstuff, wet feed, binder, bird feedstuff rod, rodent feedstuff rod, fish bait, supplement feedstuff, feedstuff for particular nutritional purposes and dietary feedstuff.

9. The method according to claim 1, characterized in that the animal need is animal bedding.

10. The method according to claim 1, characterized in that the hygiene product is selected from the group consisting of diapers, incontinence articles like protective trousers or incontinence pants, sanitary towels, tampons, panty liners and softcups.

11. The method according to claim 1, characterized in that the personal care product is selected from the group consisting of soap, shower gel, bath additives, skin creams, lotions, gel, sunscreen, sun cream, repellent, shaving cream, shaving soap, epilator cream, toothpaste, dentition adhesive medium, shampoo, hair forming agents, hair-setting products, hair colorants, facial make-up, eye care products, lip care products, nail polish and self-tanning agents.

12. The method according to claim 1, characterized in that the cleaning agent is selected from the group consisting of detergent, bile soap, washing-up liquid, dishwasher detergent, rinsing agent, neutral cleaner, abrasive cleaner, window cleaner, lime remover, drain cleaner, brake cleaner, alcohol cleaner, all-purpose cleaner, glass cleaner, sanitary cleaner, toilet cleaner, toilet gel, toilet soap, carpet cleaner, car care material, oven cleaner, bathroom cleaner and metal polish, oil absorbing and anti-dust agent.

13. The method according to claim 1, characterized in that the coating agent is selected from the group consisting of antistatic coating, oil-repellent coating and anti-block coating.

14. The method according to claim 1, characterized in that the explosive is a gelatinous explosive.

15. The method according to claim 1, characterized in that the lubricant is selected from the group consisting of liquid lubricant, such as lubricating oil and cooling lubricant, lubricating grease and solid lubricant.

16. The method according to claim 1, characterized in that the plastic product is a citrus fiber-reinforced plastic or a wood-plastic composite (WPC).

17. The method according to claim 1, characterized in that the varnish is selected from the group consisting of alkyd resin varnish, oil varnish, cellulose nitrate varnish, bitumen varnish, tar-containing varnish, phenolic resin varnish, urea resin varnish, melamine resin varnish, polyester varnish, epoxy resin varnish, polyurethane resin varnish, acrylic varnish and powder varnish.

18. The method according to claim 1, characterized in that the coating agent is selected from the group consisting of glaze, oil paint, dispersion paint, chalk paint, silicate paint and liquid plaster.

19. The method according to claim 1, characterized in that the construction material is selected from the group consisting of building foam, sound proofing material, insulation material, concrete, screed, mortar, cement, chemical bonded anchors, chemical anchor bolts, asphalt and whisper asphalt.

20. The method according to claim 1, characterized in that the adhesive is selected from the group consisting of dispersion adhesive, melt adhesive, plastisol, cyanoacrylate adhesive, methyl methacrylate adhesive, unsaturated polyester adhesive, epoxy adhesive, polyurethane adhesive, silicones, phenolic resin adhesive, polyimide adhesive, polysulfide adhesive, bismaleimide adhesive, adhesive based on silane-modified polymers, silicone adhesive, paste.

21. The method according to claim 1, characterized in that the fertilizer is a binder for fertilizer cones.

22. The method according to claim 1, characterized in that the drug is selected from the group consisting of powder, juice, lotion, ointment, cream, gel, tablet and rubber article.

23. The method according to claim 1, characterized in that the medical product is selected from the group consisting of wound dressing, emergency bandage, transdermal patch, stoma product and dental casting compound.

24. The method according to claim 1, characterized in that the battery is selected from the group consisting of primary cell, accumulator and solid cell battery.

25. The method according to claim 2, characterized in that use in the construction area comprises usage in road and path construction, masonry construction, concrete construction and reinforced concrete construction.

26. The method according to claim 2, characterized in that the use in extraction by drilling boreholes comprises the usage as an additive to a drilling fluid or fracfluid.

27. The method according to claim 2, characterized in that the use in agriculture comprises the usage in fertilizers, humectants, soil conditioners, plant substrates, flowerpots and substrate-tablet extrudates.

28. Product selected from the group consisting of food products, feeding stuff, commodity goods, animal need, hygiene products, personal care products, cleaning agents, coating agents, care agents, explosives, lubricants, cooling agents, plastic products, fabrics, imitation leather, varnish, ink, paints, building materials, composite materials, paper, cardboard, adhesives, fertilizers, drugs, medical products, batteries, characterized in that it comprises an activatable, de-esterified, pectin-converted fruit fiber according to claim 4.

29. Product according to claim 28, wherein the portion of activatable, de-esterified, pectin-converted fruit fiber is between 0.05 wt% and 90 wt%, preferably between 0.1 and 50 wt%, particularly preferably from 0.1 to 25 wt% and especially preferably between 0.5 and 10 wt%.
